(19) United States
(12) Patent Application Publication
(10) Pub. No.: US 2012/0047008 A1
(43) Pub. Date: Feb. 23, 2012

(54) Selective Distribution Of Rewards

(75) Inventors: Laurent Daniel Alhadeff, New York, NY (US); Richard Adam Smullen, New York, NY (US)

(73) Assignee: Beezag Inc.

(21) Appl. No.: 13/209,381

(22) Filed: Aug. 13, 2011

Related U.S. Application Data
(60) Provisional application No. 61/374,265, filed on Aug. 17, 2010.

(51) Int. Cl. G06Q 30/00

(52) U.S. Cl. 705/14.16; 705/14.17

(57) ABSTRACT

A computer implemented method and system for selectively distributing rewards to a user is provided. A rewards management platform is provided for managing the rewards of the user. The rewards management platform compensates the user with the rewards based on one or more activities, for example, confirming viewing of multimedia content, referring the multimedia content to other users, etc., performed by the user on the rewards management platform. The user selects one or more of multiple deposit accounts associated with the user via a graphical user interface for allocating one or more of the rewards. Each of the deposit accounts is associated with a conversion rate. The rewards management platform establishes an electronic connection to each of the selected deposit accounts via a communication network. The rewards management platform distributes the allocated rewards to the selected deposit accounts based on the conversion rate via the established electronic connection.

### CROSS REFERENCE TO RELATED APPLICATIONS

This application claims the benefit of provisional patent application No. 61/374,265 titled “Selective Distribution Of Rewards”, filed on Aug. 17, 2010 in the United States Patent and Trademark Office.

The specification of the above referenced patent application is incorporated herein by reference in its entirety.

### BACKGROUND

The computer implemented method and system disclosed herein, in general, relates to a rewards management system. More particularly, the computer implemented method and system disclosed herein relates to selectively distributing rewards to a user.

Advertising platforms offer incentives in the form of rewards to users for viewing advertisements of companies that seek to advertise their products and services through the advertising platforms. Conventional advertising platforms limit redemption of the rewards to predefined outlets, thereby precluding a user from selecting a means for redeeming the rewards. Moreover, the rewards may be restricted, for example, to commodities, discounts, etc., offered at specified outlets or websites. For example, a user who views an online video advertisement promoting a soft drink may be compensated with rewards such as a discount on the soft drink or special offers made by the company that produces the soft drink. However, the user may not be interested in the offers made by the soft drink company, and may instead be interested in using the rewards for a desired item of value. For example, the user may instead be interested in converting the rewards to cash and using the cash for purchasing an item that the user wants.

Furthermore, the user may not be interested in converting the rewards to cash if the amount of cash derived after conversion is too less. Instead the user may wish to convert the rewards to virtual currency that the user may wish to use for online gaming activities, which in turn may earn the user a substantial amount of cash on winning an online game. Existing advertising platforms may not allow users to convert the rewards earned by a user to a tangible physical currency or allow the transfer of the rewards to an electronic payment account used for paying another individual or a business. The user is therefore not allowed to utilize the rewards in a convenient and desired manner.

Furthermore, a user performing online activities on different platforms may earn rewards for performing the online activities on each of the platforms individually. However, the user cannot accrue and reallocate the rewards earned across different platforms for collective use in a desired manner. Conventional advertising platforms do not provide the flexibility of suitably reallocating the rewards obtained from different online activities across different platforms. The user may, for example, desire to reallocate a fraction of the rewards from one account to an online poker account which may fetch the user greater rewards that can be converted to cash. Therefore, the user may desire to use the rewards accrued from different online activities for benefits across different platforms that suit the convenience and needs of the user.

Hence, there is a long felt but unresolved need for a computer implemented method and system that provides an integrated rewards management platform for converting, selectively distributing, and flexibly managing rewards earned by the user from performance of multiple activities on the rewards management platform. Moreover, there is a need for a computer implemented method and system that allows a user to reallocate and convert the rewards earned across different platforms into desired items of value for use in a desired manner across other different platforms. Furthermore, there is a need for a computer implemented method and system that establishes equivalence between different user incentive systems availed by the user on different external platforms to allow maintenance of a collective and uniform reward accrual system for the user.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein addresses the above mentioned needs for providing an integrated rewards management platform that converts, selectively distributes, and flexibly manages rewards earned by a user from performance of multiple activities on the rewards management platform. Moreover, the computer implemented method and system disclosed herein allows a user to reallocate and convert the rewards earned across different platforms into desired items of value for use in a desired manner across other different platforms. Furthermore, the computer implemented method and system disclosed herein establishes equivalence between different user incentive systems availed by the user on different external platforms to allow maintenance of a collective and uniform reward accrual system for the user.

The computer implemented method and system disclosed herein provides a rewards management platform for managing rewards of a user, for example, in a networked environment. The rewards are, for example, virtual points, virtual currencies, etc., that can be allocated and converted into real or virtual points, currency, cash of value, etc., with one or more merchants, services comprising gems and social games, charities, virtual products, virtual services, etc. The rewards management platform compensates the user with the rewards based on one or more activities performed by the user on the rewards management platform. The activities performed by the user comprise, for example, one or more of opting to receive multimedia content from the rewards management platform and/or third party platforms, confirming viewing of the multimedia content by the user, referring the multimedia content to other users, accessing the referred multimedia content, registering into a virtual community network created on the rewards management platform based on referrals, providing authentic marketing data for enabling targeting of the multimedia content to the user, etc. As used herein, the term “virtual community network” refers to a social network of persons or users, for example, viewers, who interact through specific media to pursue mutual interests and goals.

In an embodiment, the rewards management platform confirms the viewing of the multimedia content, for example, by generating a challenge, random in content, presenting the generated challenge to the user, and invoking a response from the user to the presented challenge. The challenge is, for example, one or more of unrelated to the multimedia content, presented at random times during play of the multimedia content and/or after play of the multimedia content, and presented at random physical locations on the multimedia content. The rewards management platform presents the generated challenge to the user by overlaying the generated challenge on the multimedia content or inserting the generated challenge on interruption of play of the multimedia content. When the user successfully responds to the presented challenge, a correct or a partially correct response to the challenge indicates a confirmation that the multimedia content has been viewed.

In an embodiment, the rewards management platform compensates the user with the rewards, for example, by crediting the rewards to a user account created for the user on the rewards management platform. The rewards management platform creates the user account based on inputs received from the user via a graphical user interface (GUI) provided by the rewards management platform to the user. In an embodiment, the rewards management platform provides the user with an electronic wallet associated with the user account for accruing the rewards over a period of time. In an embodiment, the rewards management platform targets multimedia content to the user during creation of the user account.

The user selects one or more of multiple deposit accounts associated with the user via the GUI for allocating one or more of the rewards. As used herein, the term “deposit accounts” refers to accounts, for example, charity deposit accounts, cash deposit accounts, virtual currency accounts, social networking accounts, etc., held by the user on external platforms, for example, charity platforms, banking platforms, online social networking platforms, etc., or on the rewards management platform. The deposit accounts allow deposition or withdrawal of rewards by a user, where the rewards are measured, for example, in physical currency, virtual currency or any other units, for example, reward points, reward scores, etc. In an embodiment, the rewards management platform creates one or more deposit accounts for the user on the rewards management platform based on inputs received from the user via the GUI. The user allocates one or more of the rewards to the created deposit accounts via the GUI for direct distribution to electronic payment accounts associated with the user.

Each of the deposit accounts is associated with a conversion rate. In an embodiment, the rewards management platform converts the rewards to a currency, for example, cash, checks, physical currency, etc., based on the conversion rate, and transfers the currency to a third party associated with the user via an electronic payment account associated with the user, on receiving an indication from the user via the GUI for transferring the currency. As used herein, the term “third party” refers to business organizations, individuals, etc., who are associated with the user and conduct financial transactions with the user. The electronic payment account is, for example, a PayPal™ account, a credit card account, etc. In an embodiment, the rewards management platform allows the allocation of one or more of the rewards to one or more of the selected deposit accounts based on predetermined criteria comprising, for example, type of rewards, an allocation threshold, etc. The allocation threshold refers to a minimum number of reward units that needs to be accrued by the user in the user account for allocation to the selected deposit accounts. As used herein, the term “reward units” refers to a measure or quantity of rewards collected by the user, for example, in terms of reward points, scores, etc.

In an embodiment, the rewards management platform reallocates one or more of the allocated rewards between the deposit accounts associated with the user based on inputs received from the user via the GUI prior to distribution of the allocated rewards to the deposit accounts. In an embodiment, the rewards management platform charges a fee to the user for the reallocation of the allocated rewards between the deposit accounts associated with the user.

The rewards management platform establishes an electronic connection to each of the selected deposit accounts via a communication network. The rewards management platform distributes the allocated rewards to the selected deposit accounts based on the conversion rate associated with the selected deposit accounts via the established electronic connection. In an embodiment, the rewards management platform defines a distribution threshold for each of the deposit accounts. The rewards management platform performs the distribution of the allocated rewards to one or more of the selected deposit accounts based on the distribution threshold defined for the selected deposit accounts. The distribution threshold for each of the selected deposit accounts is a minimum number of reward units that need to be allocated by the user to each of the selected deposit accounts to allow the rewards management platform to distribute the allocated rewards to the selected deposit accounts.

In an embodiment, the rewards management platform determines distribution criteria from the user via the GUI. The distribution criteria comprise, for example, a time for distributing the allocated rewards to the selected deposit accounts, the number of units of the allocated rewards to be distributed to the selected deposit accounts at the time specified, etc. The rewards management platform performs the distribution of the allocated rewards to the selected deposit accounts based on the distribution criteria. In another embodiment, the rewards management platform allows the user to select one or more of the selected deposit accounts having the allocated rewards via the GUI for the distribution of the allocated rewards.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method for selectively distributing rewards to a user.

FIG. 2 illustrates a computer implemented system for selectively distributing rewards to a user.

FIG. 3 exemplarily illustrates the architecture of a computer system employed by a rewards management platform for selectively distributing rewards to a user.

FIGS. 4A-4G exemplarily illustrate screenshots of a graphical user interface provided by the rewards management platform that selectively distributes rewards to a user.

FIGS. 5A-5C exemplarily illustrate a flowchart comprising the steps for selectively distributing rewards to a user based on activities performed by the user on the rewards management platform.

FIGS. 6A-6B exemplarily illustrate a flowchart for selectively distributing rewards to a user for transferring the rewards to an electronic payment account associated with the user.

### DETAILED DESCRIPTION OF THE INVENTION

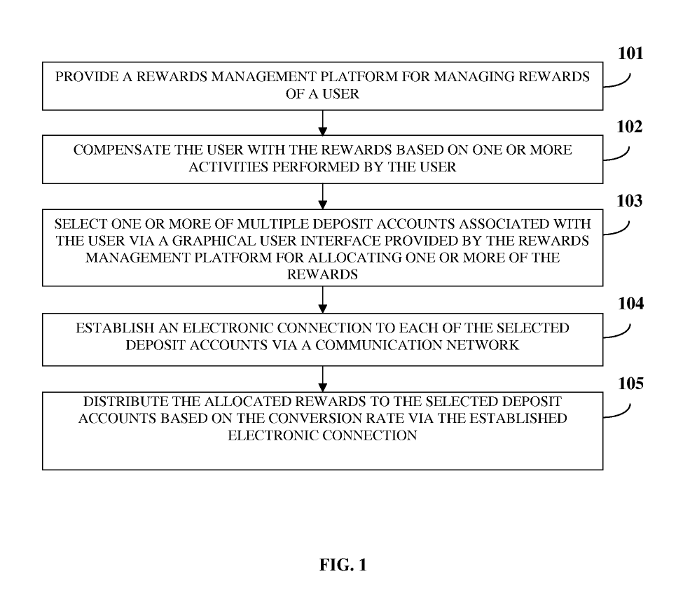

FIG. 1 illustrates a computer implemented method for selectively distributing rewards to a user. The computer implemented method disclosed herein provides 101 a rewards management platform for managing the rewards of the user, for example, in a networked environment. The rewards management platform is hosted, for example, on an online server, and is accessible in the networked environment via a communication network. The rewards management platform is accessible, for example, through a wide spectrum of technologies and devices such as general packet radio service (GPRS), 3G or other internet enabled cellular phones and tablet computing devices, computers with connection to the internet, televisions with digital set top boxes, etc. As used herein, the term “user” refers to a person who accesses the rewards management platform for performing one or more activities, for example, viewing multimedia content, referring the multimedia content to other users, etc., and for receiving rewards for performing the activities on the rewards management platform. Also, as used herein, the term “rewards” refers to items of value, for example, virtual points, virtual currencies, etc., that can be allocated and converted into real or virtual points, currency, cash of value, etc., with one or more merchants, services, charities, virtual products, virtual services, etc. The rewards comprise, for example, points, points redeemable for cash, points redeemable for items of value, scores, scores redeemable for cash, scores redeemable for items of value, cash, units of virtual currency, and other items of value.

The rewards management platform compensates 102 the user with the rewards based on one or more activities performed by the user on the rewards management platform. The activities performed by the user comprise, for example, one or more of opting to receive multimedia content from the rewards management platform and/or third party platforms, confirming viewing of the multimedia content by the user, referring the multimedia content to other users, accessing the referred multimedia content, for example, on the rewards management platform, registering into a virtual community network created on the rewards management platform based on referrals, providing authentic marketing data for enabling targeting of the multimedia content to the user, etc. As used herein, the term “virtual community network” refers to a social network of persons or users, for example, viewers, who interact through specific media to pursue mutual interests and goals. Also, as used herein, the term “marketing data” refers to selected population characteristics as used in marketing research, opinion research, etc. The marketing data comprises, for example, race, age, income, disabilities, mobility in terms of travel time to work or number of vehicles available, type of car, vacation preferences, educational attainment, home ownership, employment status, geographical location, etc.

In an example, the rewards management platform compensates the user by crediting one or more rewards into a user account created for the user on the rewards management platform, if the user confirms viewing of multimedia content, for example, an advertisement clip of a product. The rewards management platform creates the user account based on inputs received from the user via a graphical user interface (GUI) provided by the rewards management platform to the user. As used herein, the term “multimedia content” refers to content in different combined and individual formats, for example, text, audio, video, audiovisual, still images, animations, and rich content formats. In an embodiment, the rewards management platform targets multimedia content to the user during the creation of the user account for the user on the rewards management platform.

In another example, the rewards management platform compensates the user with one or more rewards for referring the multimedia content to other users for creation of a virtual community network on the rewards management platform. In another example, the rewards management platform compensates the user with one or more rewards, if the other users access the referred multimedia content and/or register with the rewards management platform to become members of the virtual community network. In another example, the rewards management platform compensates the user with one or more rewards, if the user provides authentic marketing data that may be employed for targeting the multimedia content to the user. The details of compensating the user are disclosed in the co-pending application Ser. No. 12/822,526 titled “View Confirmation For On-demand Multimedia Content”, the co-pending application Ser. No. 12/829,636 titled “Virtual Community For Incentivized Viewing Of Multimedia Content”, and the co-pending application Ser. No. 12/844,177 titled “Targeting Multimedia Content Based On Authenticity Of Marketing Data”.

In an embodiment, the confirmation of viewing of the multimedia content comprises generating a challenge, random in content, presenting the generated challenge to the user, and invoking a response from the user to the presented challenge by the rewards management platform. The challenge is, for example, one or more of unrelated to the multimedia content, presented at random times such as during play of the multimedia content, after play of the multimedia content, or both during play of the multimedia content and after play of the multimedia content, presented at random physical locations on the multimedia content, etc. The challenge, random in content, comprises, for example, one or more of a random number, a random icon, a random shape, a product logo, a service logo, a random color, a random mathematical equation, and a random target on the display screen of a client device of the user to interact therewith using touch or a pointing device. The challenge, random in content, is overlaid at different positions on the multimedia content. In an embodiment, the challenge is pseudorandom in content. The content of the challenge comprises, for example, numbers, letters, shapes, phrases, etc., from a predefined set. The challenge, random in content, is overlaid using technologies, for example, Adobe® Flash of Adobe Systems Incorporated or other video creation standards.

In an embodiment, the rewards management platform provides the user with an electronic wallet associated with the user account created for the user on the rewards management platform for accruing the rewards over a period of time. For example, the rewards management platform collects the rewards accrued from online activities conducted by the user on the rewards management platform and/or different platforms over a period of time. The rewards management platform collects, for example, rewards received from viewing interactive online advertisements across different websites, rewards for participating in online shopping surveys and quizzes, etc. The rewards management platform may collect financial details of the user, for example, banking account details, etc., of multiple banking accounts held by the user and stores the financial details on the rewards management platform to allow the user to easily retrieve the user's financial details for transferring rewards to the banking accounts or for conducting financial transactions in activities such as online shopping, etc. The rewards management platform enables transferring of the accrued rewards from the electronic wallet to one or more banking accounts. In an embodiment, the electronic wallet provided by the rewards management platform records and provides details on the online transactions conducted by the user over a period of time.

The rewards management platform enables the user to select 103 one or more of multiple deposit accounts associated with the user via the GUI provided by the rewards management platform for allocating one or more of the rewards. As used herein, the term “deposit accounts” refers to accounts, for example, charity deposit accounts, cash deposit accounts, virtual currency accounts, social networking accounts, etc., held by the user on external platforms, for example, charity platforms, banking platforms, online social networking platforms, etc., or on the rewards management platform. As used herein, the term “external platform” refers to a platform accessed by a user and on which the user holds a deposit account. The external platform is external to the rewards management platform. The deposit accounts allow the deposition or withdrawal of rewards by the user, where the rewards are measured, for example, in physical currency, virtual currency or other units such as reward points, reward scores, etc.

Each of the deposit accounts is associated with a conversion rate. The conversion rate is determined based on a mutual agreement between the rewards management platform and the external platforms. In an embodiment, if the user is associated with only a single deposit account, the rewards management platform deposits all the rewards to the available single deposit account. For example, if the user has only a single deposit account to deposit all the rewards, the rewards management platform infers that all the rewards need to be distributed to the available single deposit account. Therefore, in this case, the user does not actively select the deposit account for allocation of the rewards as the rewards management platform infers that all the rewards need to be distributed to the available single deposit account. In an embodiment, the rewards management platform provides options to the users to set default preferences for the deposit accounts. For example, the user may specify that all the rewards should be distributed to deposit accounts held by the user on charity platforms, and the rewards management platform routes all received rewards to the deposit accounts held by the user on the specified charity platforms.

In an embodiment, the rewards management platform collaborates with a white label partner to deposit rewards to a single deposit account associated with the white label partner. For example, users of InboxDollars® can deposit their rewards into an InboxDollars deposit account. As used herein, the term “white label partner” refers to a business entity that utilizes the features provided by the rewards management platform for rewarding users within a framework of subsidiaries associated with the white label partner. Therefore, the rewards management platform is embedded, for example, on a website of the white label partner and is identified and promoted as belonging to the white label partner, rather than operating as a separate entity. In this embodiment, the user can select rewards only from a pool of rewards offered by the white label partner. Consider an example of a white label partner named XYZ Corporation. The XYZ Corporation may have multiple subsidiaries, for example, LMN cable network, PQR broadcasting system, etc. A rewards program offered by XYZ Corporation operates solely within the framework of the XYZ Corporation and offers rewards for products of the XYZ Corporation and its subsidiaries, for example, access to movies, merchandise, etc. In this example, the rewards management platform is implemented by XYZ Corporation which offers a white label version of selective distribution of the rewards, where the rewards offered by XYZ Corporation and its subsidiaries are deposited in a single deposit account associated with the XYZ Corporation.

In an embodiment, the rewards management platform allows allocation of one or more of the rewards to one or more of the selected deposit accounts based on predetermined criteria defined for a user account created for the user. The predetermined criteria comprise, for example, type of rewards, an allocation threshold, etc. As used herein, the “allocation threshold” for the user account refers to a minimum number of reward units that need to be accrued by the user in the user account for allocation to the selected deposit accounts. Also, as used herein, the term “reward units” refers to a measure or quantity of the rewards collected by the user, for example, in terms of reward points, scores, etc. In an embodiment, the allocation threshold is set by the rewards management platform. Consider an example where the user has a single deposit account with American Express®. The user participates in an online photography contest conducted by American Express® and is offered a gift card by American Express®. The rewards program of American Express® specifies that the user must have at least $100 in the deposit account associated with American Express® to be permitted to collect the gift card. Therefore, the rewards management platform sets the allocation threshold as $100. The rewards management platform allows the user to allocate reward units accrued in the user account to the single deposit account of American Express® only if the user has accrued a number of reward units equivalent to $100 in the user account on the rewards management platform.

In another embodiment, the rewards management platform sets an allocation threshold by considering individual distribution thresholds of the selected deposit accounts and by selecting the minimum of the individual distribution thresholds. As used herein, the distribution threshold for each of the selected deposit accounts is a minimum number of reward units that needs to be allocated by the user to each of the selected deposit accounts, to allow the rewards management platform to distribute the allocated rewards to the selected deposit accounts. Consider an example where the user holds deposit accounts on multiple external platforms such as a charity deposit account on a charity platform, an American Express® deposit account on the American Express® platform, and a facebook account on the facebook website. The rewards management platform in communication with each of the external platforms may set distribution thresholds for the deposit accounts. For example, the rewards management platform in communication with the charity platform may set a distribution threshold equivalent to 400 reward points for the charity deposit account, a distribution threshold equivalent to 200 reward points for the American Express® deposit account, and a distribution threshold equivalent to 750 reward points for the facebook account. The rewards management platform checks the distribution thresholds of the deposit accounts and determines that the user needs to accrue at least 200 reward points in the user account to claim an item of value from at least one of the external platforms. The rewards management platform selects the minimum of the individual distribution thresholds, for example, the distribution threshold set by the American Express® website, and sets the allocation threshold for the user account to 200 reward points. When the user accrues 200 reward points in the user account, the user can allocate the reward points to the American Express® deposit account for claiming an item of value from the American Express® platform.

In another example, the rewards management platform may specify that the user is allowed to allocate rewards, for example, reward points, to a particular deposit account selected by the user, only if the total number of reward points accrued in the user account exceeds “X” number of reward points. The “X” number of reward points is the allocation threshold for the user account. If the accrued number of reward points in the user account is less than the allocation threshold, the rewards management platform notifies the user that a sufficient number of reward points has not been accrued in the user account to allow for allocation to a deposit account selected by the user. In an embodiment, the rewards management platform monitors the total number of rewards accrued by the user in the user account and prompts the user to allocate the rewards to one or more deposit accounts if the total number of rewards accrued by the user in the user account equals or exceeds the allocation threshold.

In an embodiment, the rewards management platform also allows or disallows allocation of the rewards to the selected deposit accounts based on the type of rewards earned by the user. For example, if the user earns access to premium multimedia content as a reward and selects a charity deposit account for allocation of the reward, the rewards management platform disallows allocation of the premium multimedia content to the charity deposit account and requests the user to select another deposit account for allocating the reward. In an embodiment, the rewards management platform may allow the user to allocate only a specific type of reward to some of the selected deposit accounts that are non-transferable to other deposit accounts. Further, the rewards management platform allows the user to allocate a more generic set of rewards to some deposit accounts that are transferable to other deposit accounts. Therefore, the rewards management platform provides a hybrid approach towards allocation of rewards to the selected deposit accounts. For example, a user who watches a movie trailer may be compensated with a discount of $5 on the movie tickets for the movie whose trailer was viewed by the user. The rewards management platform disallows the user, for example, from exchanging the discounted movie tickets for another movie, reallocating the $5 to a charity deposit account, using the discount of $5 for purchasing items of value such as clothing, accessories, other products, etc. However, the rewards management platform may allow the user to reallocate rewards, for example, reward points earned from playing an online game to a charity deposit account.

In an embodiment, the rewards management platform creates one or more deposit accounts for the user on the rewards management platform that can be used for distribution of the rewards to electronic payment accounts associated with the user. The rewards management platform creates these deposit accounts for the user based on inputs received from the user via the GUI. The inputs provided by the user are, for example, a user name, password, details of an electronic payment account that is to be associated with the created deposit account, etc. The user allocates one or more of the rewards to the created deposit accounts via the GUI for direct distribution to the electronic payment accounts associated with the user. For example, the user can create one or more deposit accounts on the rewards management platform that pay directly to PayPal™ accounts of the user. In this embodiment, the rewards management platform converts the rewards to a currency or cash at a determined conversion rate and pays a business or an individual associated with the user via the electronic payment accounts, on receiving an indication of the cash amount to be paid to the business or the individual and a “cash-out” indication from the user. As used herein, the term “cash-out” refers to a procedure initiated by the user for drawing the accrued rewards from the deposit account to utilize the rewards for different transactions, for example, for transferring the rewards to another account, for purchasing an item of value, etc.

In an embodiment, the user can create one or more deposit accounts on the rewards management platform to become members of rewards programs of external platforms. The user can therefore sign up for other rewards programs offered by the external platforms via the rewards management platform.

The rewards management platform establishes 104 an electronic connection to each of the selected deposit accounts via a communication network. As used herein, the term “electronic connection” refers to a connection established by the rewards management platform with one or more external platforms over the communication network, for example, the internet, a wireless network, a mobile communication network, etc. In an embodiment, the rewards management platform establishes a connection to the selected deposit accounts on the external platforms using access information, for example, login credentials provided by the user. The process of establishing electronic connections between the rewards management platform and the deposit accounts on external platforms and distributing the rewards to the selected deposit accounts is specific to each of the deposit accounts. For example, the rewards management platform may convert the rewards accrued by the user in a deposit account, for example, to points in an airlines frequent flyer rewards program, rewards in an American Express® rewards program managed by the American Express Company, currency directed to a pre-paid phone card, etc. Each of the rewards programs offered by the external platforms may use proprietary methods to allow the rewards management platform to deposit and link the rewards. The proprietary methods allow transfer of secure information, for example, account login information between the rewards management platform and the external platforms for linking and distributing the rewards. The proprietary methods comprise, for example, virtual private network (VPN) interfaces, secure network interfaces, a combination of VPN interfaces and secure network interfaces, program specific application programming interfaces (APIs), web services information transfer protocols such as a hypertext transfer protocol (HTTP) that utilize standards such as extensible markup language (XML) for messaging, secure data transport mechanisms such as internet protocol security (IPsec), etc.

Furthermore, rewards programs of each of the external platforms may enter into an agreement that allows transfer of rewards from a deposit account on one external platform to a deposit account on another external platform, via the rewards management platform which acts as a trusted intermediary. Consider an example where the American Express® rewards program collaborates with a Continental Airlines® rewards program provided by Continental Airlines, Inc., via the rewards management platform. The rewards offered by American Express® are in terms of reward points, while the rewards offered by Continental Airlines® are in terms of miles. The rewards management platform converts the reward points of American Express® to miles of Continental Airlines®. The rewards management platform establishes an electronic interface to link the deposit accounts of the user on the respective external platforms. The procedure of establishing the electronic interface comprises, for example, performing an authorization procedure, using transfer APIs to transfer account information, establishing a secure link to the deposit accounts, and transporting the rewards from one deposit account to another deposit account. The rewards management platform allows an authorization procedure between the two rewards programs on the respective external platforms comprising, for example, user identity verification, verification of credentials of the deposit accounts, etc., to enable a secure transfer of rewards between the deposit accounts. The rewards management platform enables the user to allocate points from a deposit account on American Express® to a deposit account on Continental Airlines®.

The rewards management platform distributes 105 the allocated rewards to the selected deposit accounts based on the conversion rate via the established electronic connection. The rewards management platform makes the rewards compensated to the user equivalent to rewards that already hold value in the deposit accounts associated with the user. In an embodiment, the rewards management platform converts the rewards to a currency, for example, cash, checks, physical currency, etc., based on the conversion rate, and transfers the currency to a third party associated with the user via an electronic payment account associated with the user, on receiving an indication from the user via the GUI for transferring the currency. As used herein, the term “third party” refers to business organizations, individuals, etc., who are associated with the user and conduct financial transactions with the user. The electronic payment account is, for example, a PayPal™ account, a credit card account, etc.

In an embodiment, the rewards management platform automatically distributes the rewards into the selected deposit accounts based on application programming interfaces (APIs). The APIs provide a direct interface between the rewards management platform and each of the selected deposit accounts, thereby allowing the rewards management platform to securely transfer the rewards to the selected deposit accounts. The APIs utilize information provided by the rewards management platform, for example, a user identifier, an account identifier to identify a particular deposit account, number of rewards to be transferred to a selected deposit account, a conversion ratio for the selected deposit account, a system authorization password that can be used to identify and authorize the rewards management platform, etc., and establish a connection to the selected deposit accounts on the external platforms.

In an embodiment, the rewards management platform reallocates one or more of the allocated rewards between the deposit accounts associated with the user based on inputs received from the user via the GUI, prior to distribution of the allocated rewards to the deposit accounts. The inputs received from the user are, for example, an indication to reallocate the rewards to other deposit accounts, the number of rewards that are to be reallocated to another deposit account, etc. In an embodiment, the rewards management platform charges a fee to the user for the reallocation of the allocated rewards between the deposit accounts associated with the user. For example, if a user reallocates five hundred reward points from a charity deposit account to a swagbucks™ account, the rewards management platform may charge one percent of the total number of reallocated reward points as a fee to the user. Therefore, in this example the user pays five reward points to the rewards management platform.

In an embodiment, the rewards management platform collects and manages rewards earned by the user from performance of one or more online activities on different external platforms. The rewards management platform stores the collected rewards in the user account and allows allocation of the rewards to other deposit accounts on the rewards management platform or on other external platforms. For example, the rewards management platform collects the rewards earned by the user from participating in an online game on an online gaming platform, from participating in a survey on a social networking platform, etc., and stores the rewards in the user account created on the rewards management platform. The user may then allocate one or more rewards from the user account to one or more deposit accounts selected by the user on the rewards management platform. In another embodiment, the rewards management platform converts the rewards earned by the user on a particular external platform, for example, to an equivalent reward on another external platform and allows the user to allocate the rewards to a deposit account on the other external platform. Therefore, the rewards management platform flexibly manages the collective rewards earned by the user from performance of online activities across different platforms.

Consider an example where a user participates in an online game on the facebook website. The user earns a reward, for example, fifty virtual points for participating in the online game. The virtual points are stored in the online gaming account of the user on the facebook website. The user provides the login details of the online gaming account to the rewards management platform and requests the rewards management platform to retrieve the virtual points. The rewards management platform establishes an electronic connection over a communication network, for example, the internet, to the online gaming account on the facebook website. The rewards management platform contacts the online gaming company that provides the online game and establishes an agreement over the conversion rate to be employed for converting the virtual points to equivalent reward points that can be utilized by the user on the rewards management platform. The rewards management platform accesses the online gaming account using the login details provided by the user, retrieves the virtual points, converts the virtual points to equivalent reward points, for example, a hundred reward points at a conversion rate of 1:2, and stores the reward points in the user account on the rewards management platform.

The rewards management platform allows the user to reallocate the converted reward points to a charity deposit account maintained on an external platform, for example, a charity website. The rewards management platform converts the accrued reward points to equivalent currency, for example, twenty dollars, at a conversion rate of 5:1. The rewards management platform establishes an electronic connection to the charity website over the communication network, and distributes the twenty dollars to the charity deposit account. Further, the user can request the rewards management platform to collect the rewards earned by the user from other online rewards programs on external platforms. The rewards management platform converts the rewards earned by the user on different external platforms to equivalent reward points on the rewards management platform, based on the conversion rates agreed with the respective external platforms. The rewards management platform collects all the converted reward points in the user account and allows the user to allocate the reward points to other deposit accounts hosted on other external platforms.

In an embodiment, the rewards management platform enables creation of virtual community networks that can exchange and transfer rewards, in the form of credit, points, scores, etc. For example, multiple users in a virtual community network for an online game such as FarmVille® of Zynga Inc., can exchange rewards such as virtual currency, points, etc., with other users via the rewards management platform. The users can transfer or loan virtual currency to other users via the rewards management platform. In another example, a user can exchange rewards accrued in a particular deposit account with the rewards of another deposit account of another user who is part of the virtual community network, if the users mutually agree to exchange the rewards. This, for example, enables the operation of a “virtual economy” wherein virtual currency is transferred across the deposit accounts held by the users of the virtual community network.

In an embodiment, the rewards management platform defines a distribution threshold for each of the deposit accounts. The distribution threshold is a minimum number of reward units that needs to be allocated by the user in each of the deposit accounts, to allow the rewards management platform to distribute the allocated rewards to the deposit accounts. The rewards management platform distributes the allocated reward units to one or more of the selected deposit accounts based on the distribution threshold defined for each of the deposit accounts. In an embodiment, the rewards management platform sets the distribution threshold for each of the deposit accounts in association with the businesses or external platforms hosting the deposit accounts.

The rewards management platform defines the distribution threshold in association with each of the external platforms, for example, banking platforms, charity platforms, etc. Consider an example where American Express® offers a $100 American Express® gift card as part of a loyalty rewards program. The rewards program of American Express® may not accept a partial accrual of rewards and may stipulate that the deposit account on the rewards management platform must accrue a number of rewards equivalent to at least $100, to allow the rewards management platform to distribute the accrued rewards to the user's American Express® deposit account and allow the user to claim the American Express® gift card. The rewards management platform may define a distribution threshold of rewards that is equivalent to $100 for the American Express® deposit account to allow the user to claim the American Express® gift card.

Consider an example where a charity deposit account contains 350 reward points and a cash deposit account contains 500 reward points after the rewards management platform converts the allocated reward points based on the conversion rates of the charity deposit account and the cash deposit account. The rewards management platform defines a distribution threshold of 500 points for the charity deposit account in association with a charity platform hosting the charity deposit account. The rewards management platform defines a distribution threshold of 400 points for the cash deposit account in association with a banking platform hosting the cash deposit account. The rewards management platform compares 350 reward points in the charity deposit account with the distribution threshold of 500 reward points defined for the charity deposit account, finds that the number of reward points in the charity deposit account is less than the distribution threshold of 500 reward points defined for the charity deposit account, and does not distribute the allocated 350 reward points to the charity deposit account on the charity platform. The rewards management platform notifies the user that the number of allocated reward points is insufficient for distribution and that an additional number of reward points of above 150 points needs to be accrued in the charity deposit account to proceed with distribution. The rewards management platform, however, finds that the 500 reward points in the cash deposit account is greater than the distribution threshold of 400 reward points defined for the cash deposit account. The rewards management platform therefore distributes the 500 reward points to the cash deposit account on the charity platform.

In an embodiment, the rewards management platform monitors the total number of rewards converted and accrued by the user in each of the selected deposit accounts. If the total number of rewards in the selected deposit accounts equals or exceeds the distribution threshold, the rewards management platform automatically distributes the rewards to the selected deposit accounts.

In an embodiment, the rewards management platform determines distribution criteria from the user via the GUI for distributing the allocated rewards to the selected deposit accounts. The distribution criteria comprise, for example, a time for distributing the allocated rewards to the selected deposit accounts, the number of units of the allocated rewards to be distributed to the selected deposit accounts at the time specified, etc. For example, the user allocates rewards to a selected deposit account and specifies the distribution criteria via the GUI for the distribution of the allocated rewards to the selected deposit account. The distribution criteria are, for example, a specified number of days “D1” and a specified number of units “N1” of the rewards to be distributed to the selected deposit account. The rewards management platform waits for the specified number of days “D1” to elapse and then distributes “N1” reward units to the selected deposit account. Specifying the distribution criteria on the rewards management platform allows the user to control distribution of the allocated rewards to the selected deposit accounts.

In another embodiment, the rewards management platform allows the user to select one or more of the selected deposit accounts having the allocated rewards via the GUI for the distribution of the allocated rewards. For example, the user can allocate rewards to all the selected deposit accounts, and then instruct the rewards management platform to distribute the allocated rewards to only a subset of the selected deposit accounts.

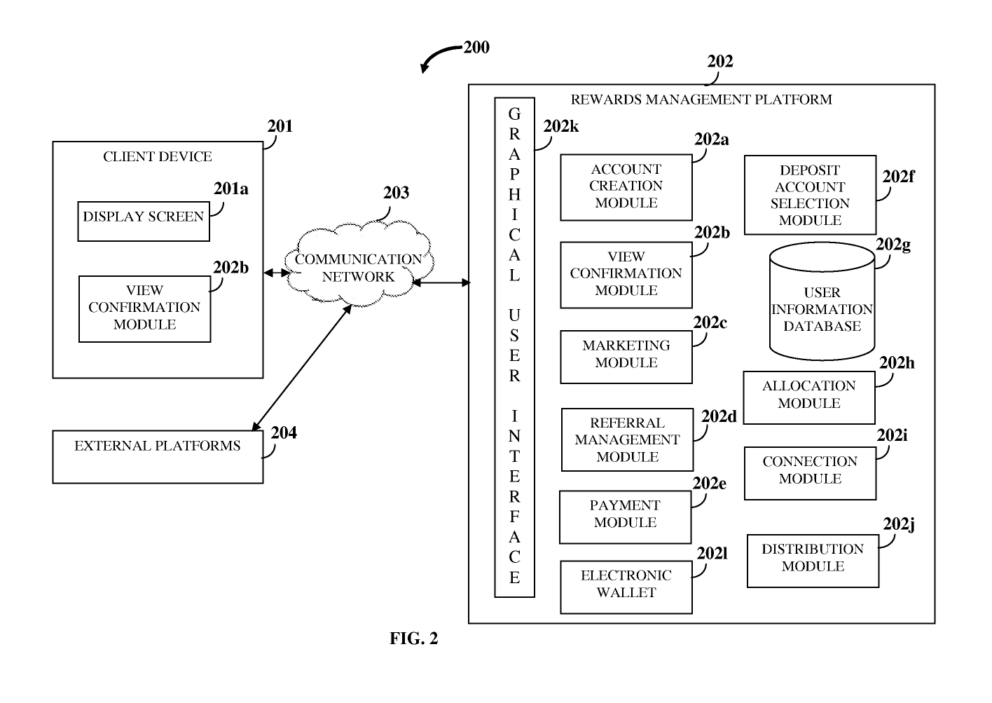

FIG. 2 illustrates a computer implemented system 200 for selectively distributing rewards to a user. The computer implemented system 200 disclosed herein comprises the rewards management platform 202 accessible by a client device 201 of the user via a communication network 203. In an embodiment, the rewards management platform 202 is hosted on a server. The client device 201 is, for example, an internet-enabled mobile device, a tablet computing device, a computer with a web browser, and a set top box capable of delivering interactive multimedia content, an internet protocol enabled device on an internet connection, etc. The client device 201 is capable of receiving multimedia content from the rewards management platform 202 in different multimedia content formats, for example, a hypertext markup language 5 (HTML5) format, the Windows® audio video format, and other proprietary and non-proprietary formats. The client device 201 receives the multimedia content, for example, an advertisement, a commercial message, an educational clip, an entertainment clip, etc., from the rewards management platform 202, and plays the multimedia content on a display screen 201a of the user's client device 201, for example, in an audiovisual format. In an embodiment, the rewards management platform 202 provides a graphical user interface (GUI) 202k through which the user can interact with the rewards management platform 202.

The rewards management platform 202 manages rewards of the user. The rewards management platform 202 comprises an account creation module 202a, a payment module 202e, a deposit account selection module 202f, an allocation module 202h, a connection module 202i, and a distribution module 202j. In an embodiment, the rewards management platform 202 comprises a user information database 202g.

The account creation module 202a creates a user account for the user based on inputs received from the user via the GUI 202k, for crediting the rewards on the rewards management platform 202. In an embodiment, the user may opt in to receive multimedia content from the rewards management platform 202 during the creation of the user account. In an embodiment, the account creation module 202a creates one or more deposit accounts for the user on the rewards management platform 202 based on inputs received from the user via the GUI 202k. The inputs received from the user comprise, for example, a user name, a password, details of an electronic payment account that is to be associated with a deposit account created on the rewards management platform 202, default preferences of deposit accounts, etc. In an embodiment, the account creation module 202a creates one or more deposit accounts on the rewards management platform 202 to allow the user to become members of rewards programs offered by external platforms 204. The allocation module 202h enables the user to allocate one or more of the rewards to the deposit accounts created by the account creation module 202a via the GUI 202k for distribution to electronic payment accounts associated with the user by the distribution module 202j.

The payment module 202e compensates the user with the rewards based on one or more activities performed by the user on the rewards management platform 202. The payment module 202e compensates the user by crediting the user with the rewards in the created user account, for example, based on the user opting to receive the multimedia content from the rewards management platform 202, the user confirming viewing of the multimedia content, the user referring the multimedia content to one or more other users, the other users accessing the multimedia content, the users registering into a virtual community network created on the rewards management platform 202 based on referrals, the user providing authentic marketing data for enabling targeting of the multimedia content to the user, etc.

In an embodiment, the computer implemented system 200 disclosed herein further comprises a view confirmation module 202b provided on the rewards management platform 202 and/or the user's client device 201 for confirming the viewing of the multimedia content by the user. The client device 201 receives the multimedia content from the rewards management platform 202 and plays the multimedia content on the display screen 201a of the client device 201. The view confirmation module 202b generates a challenge that is, for example, one or more of random in content, unrelated to the multimedia content, presented at random times during and/or after play of the multimedia content, and presented at random physical locations on the multimedia content. The view confirmation module 202b presents the generated challenge to the user on the display screen 201a of the client device 201 by overlaying the generated challenge on the multimedia content or by inserting the generated challenge on interruption of play of the multimedia content. The view confirmation module 202b invokes a response from the user to the presented challenge and generates a response report based on the response from the user. The response determines whether the user has viewed the multimedia content. The details of multimedia content view confirmation are disclosed in the co-pending application Ser. No. 12/485,955 titled “Multimedia Content Viewing Confirmation”, the co-pending application Ser. No. 544,233 titled “Multimedia Content Viewing Confirmation”, and the co-pending application Ser. No. 12/822,526 titled “View Confirmation For On-demand Multimedia Content”. In an embodiment, the client device 201 downloads the view confirmation module 202b from the rewards management platform 202 via the communication network 203. The view confirmation module 202b executes on the client device 201, collects the user's response, and conveys the user's response to the rewards management platform 202 via the communication network 203. The payment module 202e communicates with the view confirmation module 202b for compensating the user with the rewards based on confirmation of the viewing of the multimedia content by the user.

In an embodiment, the rewards management platform 202 further comprises a referral management module 202d that enables referring of the multimedia content by the user to other users, for example, one or more second users, one or more third users, and so on to one or more nth users. The referral management module 202d generates a referral report comprising information on referrals of the multimedia content made by the user to the other users. The referral management module 202d transmits the generated referral report to the payment module 202e to allow compensation of the user. The referral management module 202d monitors access of the referred multimedia content by the other users, and enables registration of the user and the other users into a virtual community network based on the referrals. The payment module 202e communicates with the referral management module 202d for compensating the user with the rewards based on referrals of the multimedia content by the user to other users. The payment module 202e also compensates the other users, for example, for referring the multimedia content to additional users, for accessing the referred multimedia content, for confirming the viewing of the referred multimedia content, for registering into the created virtual community network, etc. In an embodiment, the referring of the multimedia content for viewing by the users and crediting the users with one or more rewards creates the virtual community network.

In another embodiment, the rewards management platform 202 further comprises a marketing module 202c that acquires marketing data from the user via the GUI 202k, determines authenticity of the acquired marketing data, rates the acquired marketing data based on the determined authenticity, and targets the multimedia content to the user based on the determined authenticity and/or the rating of the acquired marketing data. The marketing data comprises, for example, demographic data, psychographic data, and behavioral data. The demographic data comprises, for example, age, sex, income, product preferences, language preferences, etc. The psychographic data comprises, for example, personality attitudes, desires, interests, lifestyles, activities, opinions, etc. The behavioral data comprises, for example, user activities such as purchase actions, clicking on coupons, web activities, etc. In an embodiment, the marketing module 202c targets multimedia content to the user during creation of the user account for the user by the account creation module 202a. The marketing module 202c generates a marketing report detailing the marketing data provided by the user and the relevance and authenticity of the provided marketing data, and transmits the marketing report to the payment module 202e to enable compensation of the user. The payment module 202e communicates with the marketing module 202c for compensating the user with one or more rewards, for example, based on rating of the acquired marketing data.

The deposit account selection module 202f enables selection of one or more of multiple deposit accounts associated with the user via the GUI 202k for allocating one or more of the rewards. In an embodiment, the deposit accounts are hosted on external platforms 204. The external platforms 204 are, for example, web servers, social networking platforms, charity platforms, banking platforms, etc. The deposit account selection module 202f prompts the user, via the GUI 202k, to provide information, for example, login information for each of the deposit accounts to enable the rewards management platform 202 to access the deposit accounts on the external platforms 204. The deposit account selection module 202f stores the login information of each of the deposit accounts in the user information database 202g. Each of the deposit accounts is associated with a conversion rate. In an embodiment, the deposit account selection module 202f displays a list of deposit accounts and the conversion rates for each of the deposit accounts, via the GUI 202k, for assisting the user in selecting a particular deposit account based on an understanding of the final value to which the allocated rewards in the deposit account translate.

In another embodiment, the deposit account selection module 202f enables setting of default preferences for selecting the deposit accounts for allocating the rewards. For example, if the user defines a set of deposit accounts as default preferences, the deposit account selection module 202f marks and stores the default preferences in the user information database 202g. This allows the allocation module 202h to automatically prompt the user for allocation of the rewards to the deposit accounts set as default preferences or allows the distribution module 202j to automatically distribute the allocated rewards to the deposit accounts that are set as part of the default preferences.

The allocation module 202h allocates one or more of the rewards to the selected deposit accounts based on inputs provided by the user via the GUI 202k. In an embodiment, the allocation module 202h presents a pop-up window on the GUI 202k that allows the user to drag and drop the rewards to be allocated to the selected deposit accounts. In an embodiment, the allocation module 202h reallocates one or more of the allocated rewards between the deposit accounts associated with the user based on inputs received from the user via the GUI 202k prior to distribution of the allocated rewards to the deposit accounts. In an embodiment, the payment module 202e, in communication with the allocation module 202h, charges a fee to the user for the reallocation of one or more of the allocated rewards between the deposit accounts associated with the user.

In an embodiment, the allocation module 202h enables allocation of the rewards by the user via the GUI 202k to one or more deposit accounts created on the rewards management platform 202, for enabling the distribution module 202j to distribute the allocated rewards to electronic payment accounts associated with the user. The allocation module 202h allows the allocation of one or more rewards to one or more of the selected deposit accounts based on predetermined criteria, for example, type of rewards, allocation threshold, etc. For example, the allocation module 202h allows allocation of the rewards from the user account to the selected deposit accounts only if the rewards deposited in the user account cross the allocation threshold as disclosed in the detailed description of FIG. 1.

The connection module 202i establishes an electronic connection to each of the selected deposit accounts hosted on the external platforms 204, via the communication network 203. In an embodiment, the connection module 202i retrieves the user provided login information from the user information database 202g, determines the destination web addresses of the external platforms 204 hosting the selected deposit accounts, establishes a connection, for example, a hypertext transfer protocol secured (HTTPS) connection to each of the external platforms 204 over the communication network 203, and uses the retrieved login information to connect to the selected deposit accounts on the external platforms 204.

The distribution module 202j distributes the allocated rewards to the selected deposit accounts based on the conversion rate associated with each of the selected deposit accounts via the electronic connection established by the connection module 202i. In an embodiment, the distribution module 202j defines a distribution threshold for each of the deposit accounts. The distribution module 202j distributes the allocated rewards to the selected deposit accounts based on the distribution threshold defined for each of the deposit accounts. In an embodiment, the distribution module 202j converts the rewards to a currency based on the conversion rate and transfers the currency to a third party associated with the user via an electronic payment account associated with the user, on receiving an indication from the user via the GUI 202k for transferring the currency.

In an embodiment, the distribution module 202j determines distribution criteria from the user via the GUI 202k for distributing the allocated rewards to the selected deposit accounts based on the distribution criteria. The distribution criteria comprise, for example, time for distributing the allocated rewards to the selected deposit accounts by the distribution module 202j, number of units of the allocated rewards to be distributed to the selected deposit accounts at the specified time by the distribution module 202j, etc. As disclosed in the detailed description of FIG. 1, the distribution module 202j allows the user to provide the distribution criteria for controlling the final distribution of the allocated rewards to the selected deposit accounts. For example, the distribution module 202j allows the user to select only a subset of the selected deposit accounts that have been allocated with the rewards via the GUI 202k for the final distribution of the allocated rewards. The deposit account selection module 202f enables selection of one or more of the selected deposit accounts having the allocated rewards by the user via the GUI 202k for the distribution of the allocated rewards by the distribution module 202j. In an embodiment, the rewards management platform 202 further comprises an electronic wallet 202l associated with the user account created for the user on the rewards management platform 202 for accruing rewards earned by the user over a period of time.

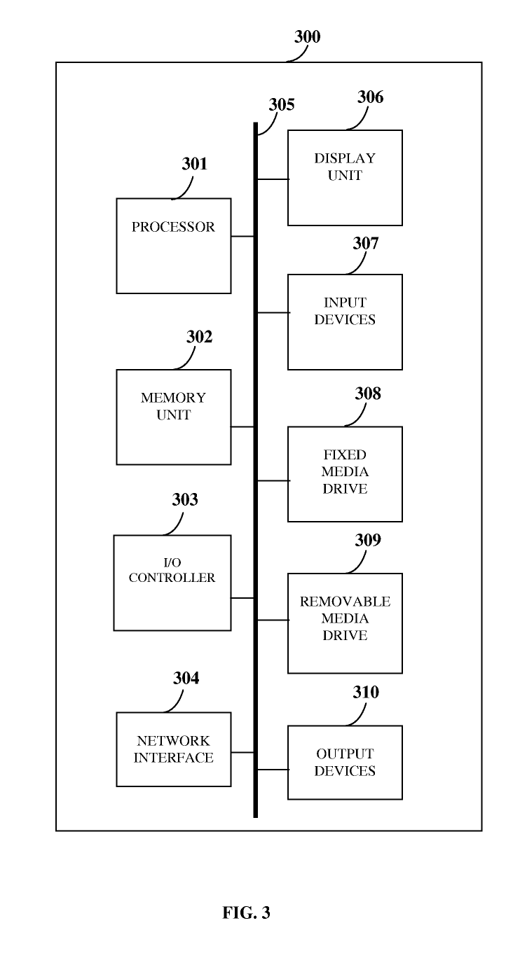

FIG. 3 exemplarily illustrates the architecture of a computer system 300 employed by the rewards management platform 202 for selectively distributing rewards to a user. The rewards management platform 202 and the user's client device 201 of the computer implemented system 200 exemplarily illustrated in FIG. 2 employ the architecture of the computer system 300 exemplarily illustrated in FIG. 3.

The rewards management platform 202 communicates with the client device 201 via the communication network 203, for example, a short range network or a long range network. The communication network 203 is, for example, the internet, a local area network, a wide area network, a wireless network, a mobile communication network, etc. The computer system 300 comprises, for example, a processor 301, a memory unit 302 for storing programs and data, an input/output (I/O) controller 303, a network interface 304, a data bus 305, a display unit 306, input devices 307, a fixed media drive 308, a removable media drive 309 for receiving removable media, output devices 310, etc.

The processor 301 is an electronic circuit that executes computer programs. The memory unit 302 is used for storing programs, applications, and data. For example, the account creation module 202a, the view confirmation module 202b, the referral management module 202d, the marketing module 202c, the payment module 202e, the deposit account selection module 202f, the allocation module 202h, the connection module 202i, and the distribution module 202j of the rewards management platform 202 are stored in the memory unit 302 of the computer system 300 of the rewards management platform 202. In an embodiment, the view confirmation module 202b of the client device 201 is stored in the memory unit 302 of the computer system 300 of the client device 201. The memory unit 302 is, for example, a random access memory (RAM) or another type of dynamic storage device that stores information and instructions for execution by the processor 301. The memory unit 302 also stores temporary variables and other intermediate information used during execution of the instructions by the processor 301. The computer system 300 further comprises a read only memory (ROM) or another type of static storage device that stores static information and instructions for the processor 301.

The network interface 304 enables connection of the computer system 300 to the communication network 203. For example, the user's client device 201 and the rewards management platform 202 connect to the communication network 203 via their respective network interfaces 304. The network interface 304 comprises, for example, an infrared (IR) interface, a WiFi interface, a universal serial bus (USB) interface, a local area network (LAN) interface, a wide area network (WAN) interface, etc. The I/O controller 303 controls the input actions and output actions performed by the user using the client device 201. The data bus 305 permits communications between the modules, for example, 202a, 202b, 202c, 202d, 202e, 202f, 202g, 202h, 202i, 202j, 202l, etc., of the rewards management platform 202.

The display unit 306 of the client device 201, via the GUI 202k, displays information received from the rewards management platform 202 to the user, for example, menus, display interfaces, icons, user interface elements such as text fields, checkboxes for selecting the deposit accounts, etc., that enable the user to perform, for example, deposit account selection, account creation, reward allocation, etc. The display unit 306 displays a view confirmation icon using which the user can initiate the execution of the view confirmation module 202b on the client device 201 by double clicking on the icon. The display unit 306 also displays multimedia content for viewing by the user, the results of view confirmation, number of rewards collected by the user, etc.

The input devices 307 are used for inputting data into the computer system 300. The user uses the input devices 307 to provide inputs to the rewards management platform 202. For example, the user initiates execution of the view confirmation module 202b, provides a response to the challenge overlaid on the multimedia content for view confirmation, selects the deposit accounts, provides login information for the selected deposit accounts, enters inputs for creating the user account, enters inputs for allocating the rewards to the selected deposit accounts, specifies the number of reward units to be allocated, etc., using the input devices 307. The input devices 307 are, for example, a keyboard such as an alphanumeric keyboard, a joystick, a pointing device such as a computer mouse, a touch pad, a light pen, etc. The user can also drag and drop rewards for allocation to the selected deposit accounts, or double click on a deposit account to allocate the rewards to a particular deposit account using an input device 307, for example, a computer mouse.

The output devices 310 output the results of operations performed by the client device 201 and the rewards management platform 202, on the client device 201. For example, the rewards management platform 202 notifies the user through a pop-up window on an output device 310 such as a display screen 201a of the user's client device 201 that distribution of the allocated rewards to a deposit account selected by the user is not possible since the number of rewards accrued in the selected deposit account has not reached the distribution threshold set for the selected deposit account. The rewards management platform 202 also displays a pop-up window on the output device 310 such as a display screen 201a of the user's client device 201 to allow the users to drag and drop reward points to a selected deposit account.

Computer applications and programs are used for operating the computer system 300. The programs are loaded onto the fixed media drive 308 and into the memory unit 302 of the computer system 300 via the removable media drive 309. In an embodiment, the computer applications and programs may be loaded directly via the communication network 203. Computer applications and programs are executed by double clicking a related icon displayed on the display unit 306 using one of the input devices 307.

The computer system 300 employs an operating system for performing multiple tasks. The operating system is responsible for management and coordination of activities and sharing of resources of the computer system 300. The operating system further manages security of the computer system 300, peripheral devices connected to the computer system 300, and network connections. The operating system employed on the computer system 300 recognizes, for example, inputs provided by the user using one of the input devices 307, the output display, files, and directories stored locally on the fixed media drive 308, for example, a hard drive. The operating system on the computer system 300 executes different programs using the processor 301.

The processor 301 retrieves the instructions for executing the modules, for example, 202a, 202b, 202c, 202d, 202e, 202f, 202g, 202h, 202i, 202j, 202l, etc., of the rewards management platform 202 from the program memory. The processor 301 also retrieves the instructions for executing the module, for example, 202b of the client device 201 from the program memory. A program counter determines the location of the instructions in the program memory. The program counter stores a number that identifies the current position in the program of the module, for example, 202b of the client device 201 and the modules, for example, 202a, 202b, 202c, 202d, 202e, 202f, 202g, 202h, 202i, 202j, 202l, etc., of the rewards management platform 202.

The instructions fetched by the processor 301 from the program memory after being processed are decoded. The instructions are placed in an instruction register in the processor 301. After processing and decoding, the processor 301 executes the instructions. For example, the account creation module 202a defines instructions for creating a user account based on inputs received from the user via the GUI 202k, for crediting the rewards earned by the user. The account creation module 202a further defines instructions for creating one or more deposit accounts for the user on the rewards management platform 202 based on inputs received from the user via the GUI 202k. The allocation module 202h defines instructions for enabling the user to allocate one or more of the rewards to the deposit accounts created by the account creation module 202a via the GUI 202k for distribution to electronic payment accounts associated with the user by the distribution module 202j.

The payment module 202e defines instructions for compensating the user with the rewards based on one or more activities performed by the user on the rewards management platform 202. For example, the payment module 202e defines instructions for compensating a user based on one or more of confirmation of viewing of multimedia content by the user, referring the multimedia content to other users by the user, providing authentic marketing data by the user for enabling targeting of the multimedia content to the user, etc.

The deposit account selection module 202f defines instructions for enabling selection of one or more of multiple deposit accounts associated with the user via the GUI 202k. The allocation module 202h defines instructions for enabling allocation of one or more of the rewards to the selected deposit accounts. The allocation module 202h further defines instructions for reallocating one or more of the allocated rewards between the deposit accounts associated with the user based on inputs received from the user via the GUI 202k prior to distribution of the allocated rewards to the deposit accounts. The allocation module 202h also defines instructions for allowing the allocation of one or more of the rewards to one or more of the selected deposit accounts based on predetermined criteria, for example, type of rewards, allocation threshold, etc. The electronic wallet 202l associated with the user account created for the user on the rewards management platform 202 defines instructions for accruing rewards earned by the user over a period of time. The connection module 202i defines instructions for establishing an electronic connection to each of the selected deposit accounts via the communication network 203.

The distribution module 202j defines instructions for distributing the allocated rewards to the selected deposit accounts based on a conversion rate associated with each of the selected deposit accounts via the electronic connection established by the connection module 202i. The distribution module 202j defines instructions for converting the rewards to a currency based on the conversion rate, and for transferring the currency to a third party associated with the user via an electronic payment account associated with the user, on receiving an indication from the user via the GUI 202k for transferring the currency.

In an embodiment, the distribution module 202j defines instructions for defining a distribution threshold for each of the deposit accounts and for distributing the allocated rewards to one or more of the selected deposit accounts based on the distribution threshold. The distribution module 202j defines instructions for determining distribution criteria, for example, time for distributing the allocated rewards to the selected deposit accounts, number of units of the allocated rewards to be distributed to the selected deposit accounts at the specified time, etc., from the user via the GUI 202k for distributing the allocated rewards to the selected deposit accounts. The deposit account selection module 202f defines instructions for enabling selection of one or more of the selected deposit accounts having the allocated rewards by the user via the GUI 202k for the distribution of the allocated rewards by the distribution module 202j.

The view confirmation module 202b defines instructions for generating a challenge, random in content, presenting the generated challenge to the user by overlaying the generated challenge on the multimedia content or inserting the generated challenge on interruption of play of the multimedia content, and invoking a response from the user to the presented challenge.

The referral management module 202d defines instructions for enabling referring of the multimedia content by the user to other users, monitoring access of the referred multimedia content by the other users, and enabling registration of the user and the other users into a virtual community network based on referrals. The marketing module 202c defines instructions for acquiring marketing data from the user via the GUI 202k, determining authenticity of the acquired marketing data, rating the acquired marketing data based on the determined authenticity, and targeting the multimedia content to the user based on the determined authenticity and/or the rating of the acquired marketing data acquired from the user.

The processor 301 of the computer system 300 employed by the rewards management platform 202 retrieves the instructions defined by the account creation module 202a, the view confirmation module 202b, the marketing module 202c, the referral management module 202d, the payment module 202e, the deposit account selection module 202f, the allocation module 202h, the connection module 202i, the distribution module 202j, the electronic wallet 202l, etc., and executes the instructions. The processor 301 of the computer system 300 employed by the client device 201 retrieves the instructions defined by the view confirmation module 202b, and executes the instructions.

At the time of execution, the instructions stored in the instruction register are examined to determine the operations to be performed. The processor 301 then performs the specified operations. The operations comprise arithmetic and logic operations. The operating system performs multiple routines for performing a number of tasks required to assign the input devices 307, the output devices 310, and memory for execution of the modules, for example, 202a, 202b, 202c, 202d, 202e, 202f, 202g, 202h, 202i, 202j, 202l, etc., of the rewards management platform 202, and the module, for example, 202b, etc., of the client device 201. The tasks performed by the operating system comprise, for example, assigning memory to the modules, for example, 202a, 202b, 202c, 202d, 202e, 202f, 202g, 202h, 202i, 202j, 202l, etc., of the rewards management platform 202, and to the module, for example, 202b, etc., of the client device 201, and to data used by the rewards management platform 202 and the client device 201, moving data between the memory unit 302 and disk units, and handling input/output operations. The operating system performs the tasks on request by the operations and after performing the tasks, the operating system transfers the execution control back to the processor 301. The processor 301 continues the execution to obtain one or more outputs. The outputs of the execution of the modules, for example, 202a, 202b, 202c, 202d, 202e, 202f, 202g, 202h, 202i, 202j, 202l, etc., of the rewards management platform 202 and the module, for example, 202b of the client device 201 are displayed to the user on the display unit 306.

Disclosed herein is also a computer program product comprising computer executable instructions embodied in a non-transitory computer readable storage medium. As used herein, the term “non-transitory computer readable storage medium” refers to all computer readable media, for example, non-volatile media such as optical disks or magnetic disks, volatile media such as a register memory, a processor cache, etc., and transmission media such as wires that constitute a system bus coupled to the processor 301, except for a transitory, propagating signal.

The computer program product disclosed herein comprises multiple computer program codes for selectively distributing rewards to a user. For example, the computer program product disclosed herein comprises a first computer program code for providing a rewards management platform 202 for managing rewards of a user, a second computer program code for compensating the user with the rewards based on one or more activities performed by the user on the rewards management platform 202; a third computer program code for enabling selection of one or more of multiple deposit accounts associated with the user via the GUI 202k by the user for allocating one or more of the rewards; a fourth computer program code for establishing an electronic connection to each of the selected deposit accounts via the communication network 203; and a fifth computer program code for distributing the allocated rewards to the selected deposit accounts based on a conversion rate associated with each of the selected deposit accounts via the established electronic connection.

The computer program product disclosed herein further comprises computer program codes for confirming viewing of multimedia content by the user by generating a challenge, random in content, presenting the challenge to the user, and invoking a response from the user to the presented challenge. The computer program product disclosed herein further comprises computer program codes for enabling referring of the multimedia content by the user to other users, monitoring access of the referred multimedia content by the other users, and enabling registration of the user and the other users into a virtual community network based on referrals. The computer program product disclosed herein further comprises computer program codes for acquiring marketing data from the user via the GUI 202k, determining authenticity of the acquired marketing data, rating the acquired marketing data based on the determined authenticity, and targeting the multimedia content to the user based on the determined authenticity and the rating of the acquired marketing data.

The computer program product disclosed herein further comprises computer program codes for reallocating one or more of the allocated rewards between the deposit accounts based on inputs received from the user via the GUI 202k prior to the distribution of the allocated rewards to the deposit accounts. The computer program product disclosed herein further comprises computer program codes for converting the rewards to a currency based on the conversion rate, and for transferring the currency to a third party associated with the user via an electronic payment account associated with the user, on receiving an indication from the user via the GUI 202k for transferring the currency. The computer program product disclosed herein further comprises additional computer program codes for performing additional steps that may be required and contemplated for selectively distributing rewards to the user.

The computer program codes comprising the computer executable instructions are embodied on the non-transitory computer readable storage medium. The processor 301 of the computer system 300 retrieves these computer executable instructions and executes them. When the computer executable instructions are executed by the processor 301, the computer executable instructions cause the processor 301 to perform the steps of the computer implemented method for selectively distributing rewards to the user. In an embodiment, a single piece of computer program code comprising computer executable instructions performs one or more steps of the computer implemented method disclosed herein for selectively distributing rewards to the user.

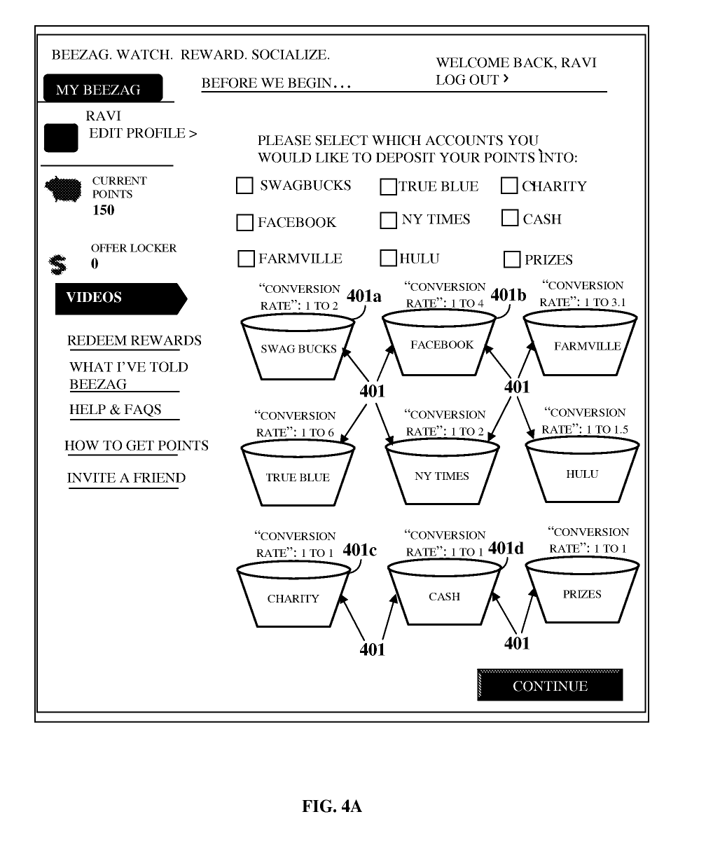

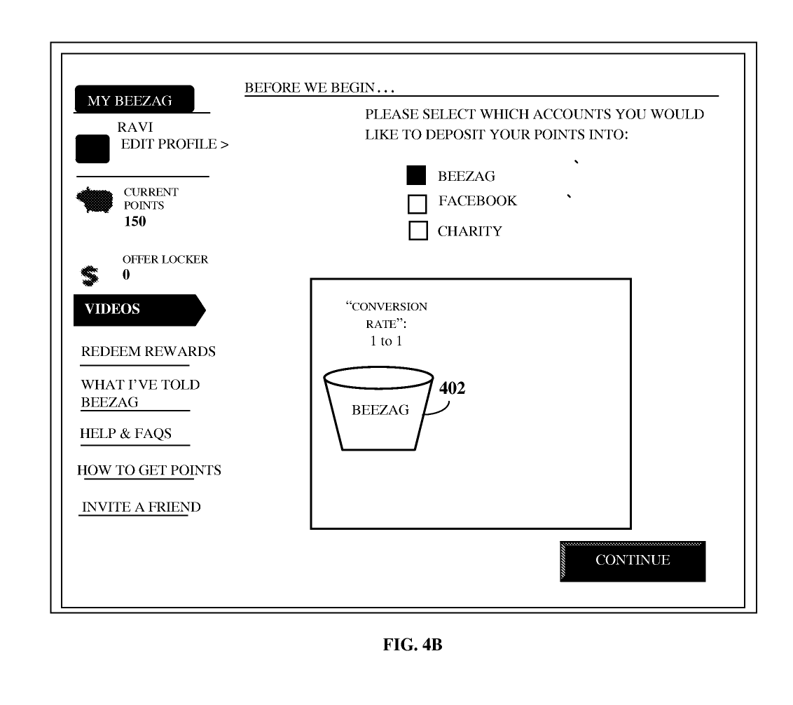

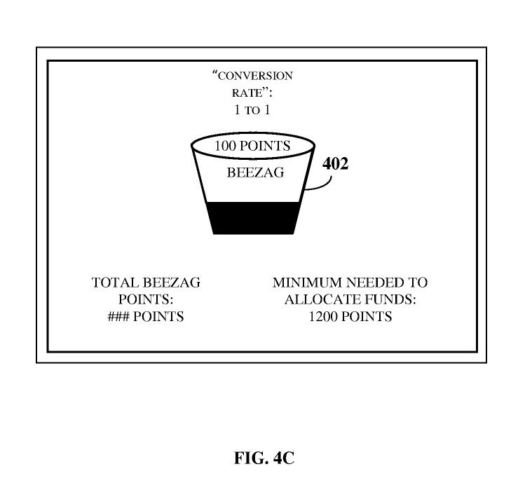

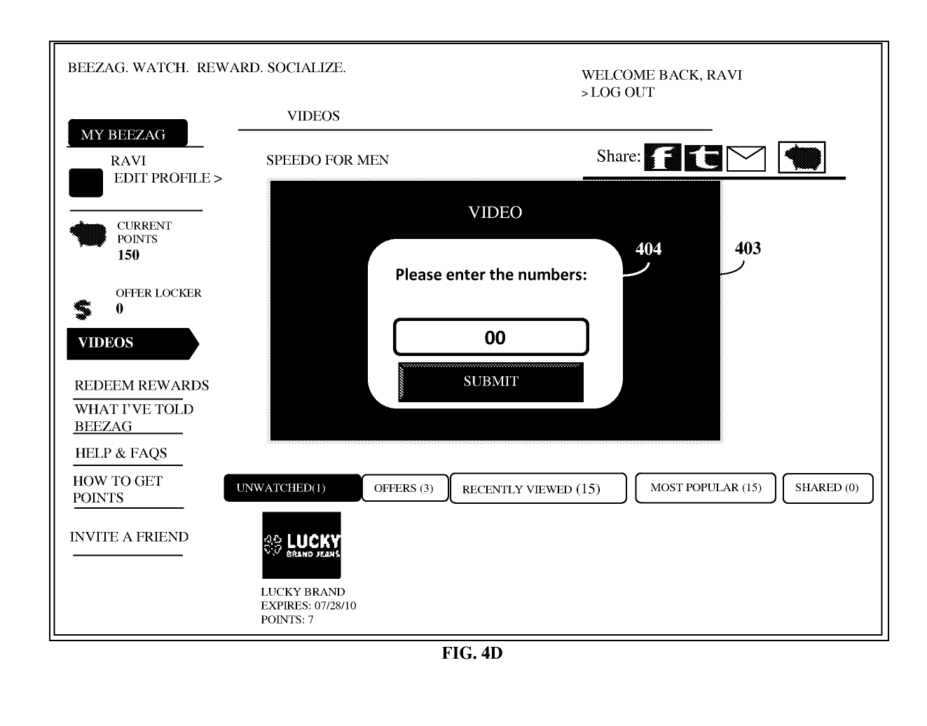

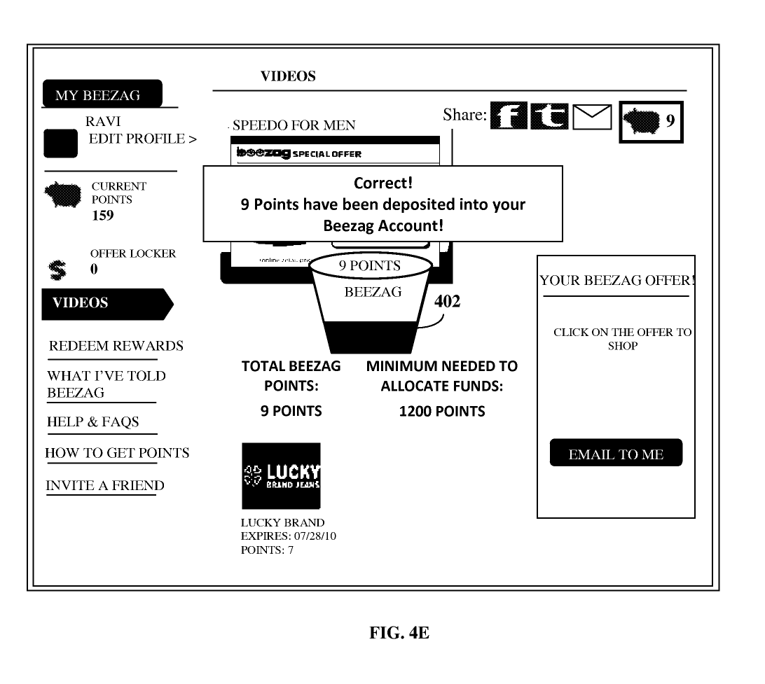

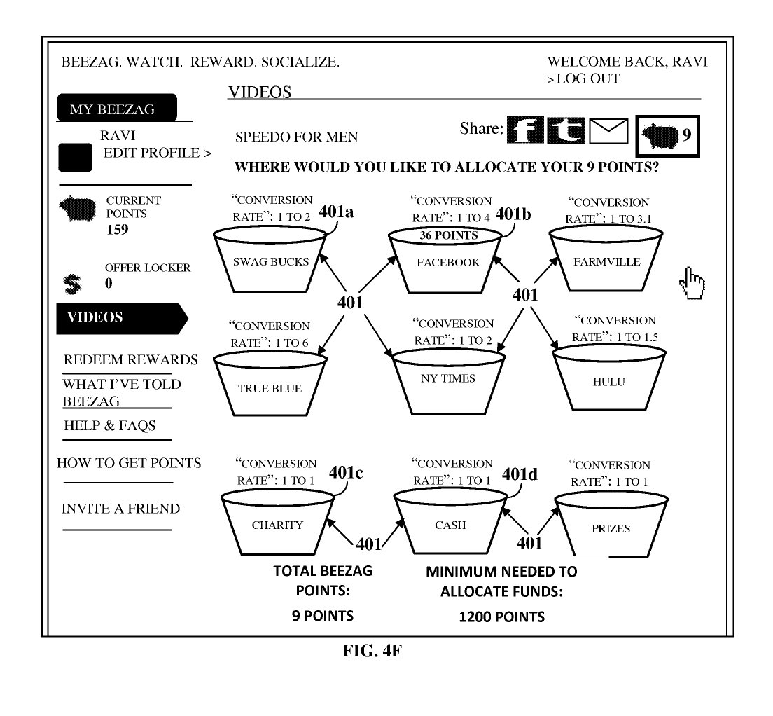

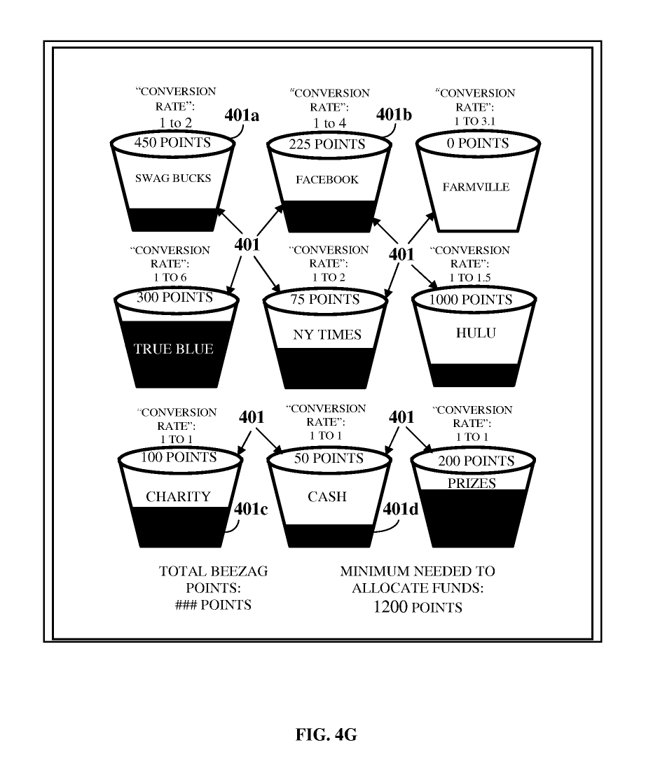

FIGS. 4A-4G exemplarily illustrate screenshots of a graphical user interface (GUI) 202k provided by the rewards management platform 202 that selectively distributes rewards, for example, reward points to a user. The user accesses the rewards management platform 202 exemplarily illustrated in FIG. 2, via a communication network 203, for example, the internet and creates a user account 402. On creation of the user account 402, the rewards management platform 202 enables the user to set default preferences for the user account 402 and deposit accounts 401. The user may also opt in to receive multimedia content, for example, a video 403, from the rewards management platform 202 as exemplarily illustrated in FIG. 4D.

The rewards management platform 202 enables the user to select one or more of multiple deposit accounts 401, for example, a swagbucks™ account 401a, a facebook account 401b of Facebook, Inc., a charity deposit account 401c, a cash deposit account 401d, etc., associated with the user via the GUI 202k for allocating one or more of the reward points as exemplarily illustrated in FIG. 4A. The rewards management platform 202 displays the deposit accounts 401 associated with the user along with the conversion rates of the deposit accounts 401. The deposit accounts 401 are represented by buckets as exemplarily illustrated in FIG. 4A, FIG. 4F, and FIG. 4G. In an embodiment, if the user is associated with only a single deposit account 401, the user is not required to select the deposit account 401. In the case of a single deposit account 401, the rewards management platform 202 infers that all the reward points accrued by the user are to be deposited into the available single deposit account 401.

The rewards management platform 202 prompts the user to provide, for example, login information for each of the selected deposit accounts 401 to ensure that the reward points are correctly distributed to the user's selected deposit accounts 401. Each of the deposit accounts 401 is associated with a conversion rate. For example, the swagbucks™ account 401a is associated with a conversion rate of 1:2, the facebook account 401b is associated with a conversion rate of 1:4, the charity deposit account 401c is associated with a conversion rate of 1:1, the cash deposit account 401d is associated with a conversion rate of 1:1, etc., as exemplarily illustrated in FIG. 4A. In an embodiment, the rewards management platform 202 enables the user to select a single deposit account 401, for example, the created user account 402 associated with a conversion rate of 1:1 as exemplarily illustrated in FIG. 4B for allocation of the reward points.

In an embodiment, the user is required to accrue a predetermined number of reward points, also referred to as the allocation threshold, in the user account 402 to be able to allocate the reward points from the user account 402 to different deposit accounts 401. For example, the rewards management platform 202 sets the allocation threshold for the user account 402 to 1200 points as exemplarily illustrated in FIG. 4C to allow allocation of the reward points to the deposit accounts 401 selected by the user. The user is required to accrue reward points to at least the allocation threshold, for example, 1200 points in the user account 402 to be able to allocate the reward points to the deposit accounts 401.

In an embodiment, each of the deposit accounts 401 associated with the user also has a distribution threshold also referred to as a cash-out threshold, where the rewards management platform 202 only distributes the allocated reward points to the selected deposit accounts 401, for example, on external platforms 204, if the reward points allocated to those selected deposit accounts 401 reach the distribution threshold of each of the selected deposit accounts 401. The rewards management platform 202 may have a transfer agreement with different merchants, businesses, services, etc., which determines the distribution threshold for executing a transfer. For example, an airline account may have a distribution threshold of above 5000 miles. In this case, if the user has accrued enough reward points in the user account 402 for allocation to the airline account, the rewards management platform 202 only distributes the reward points allocated by the user to the airline account, if the allocated reward points reach the distribution threshold of the airline account.

The rewards management platform 202 transmits or streams a video 403 selected by the user to the user's client device 201 as exemplarily illustrated in FIG. 4D for enabling the user to view the video 403 in real time or at a later time selected by the user. In an embodiment, the client device 201 receives the video 403 from the rewards management platform 202 as a progressive download. The rewards management platform 202 or the client device 201 plays the video 403 for viewing by the user. The rewards management platform 202 or the client device 201 generates and presents a challenge 404, random in content, to the user and invokes a response from the user for confirming viewing of the video 403 as exemplarily illustrated in FIG. 4D. The rewards management platform 202 verifies the correctness of the response entered by the user, indicates the correctness of the response, and compensates the user with reward points. For example, if the user enters a correct response to the presented challenge 404, the rewards management platform 202 confirms viewing of the video 403 by the user and compensates the user with 9 reward points by depositing the 9 reward points in the user account 402 as exemplarily illustrated in FIG. 4E. In an embodiment, if the reward points accrued in the user account 402 reach the allocation threshold of the user account 402, the rewards management platform 202 allows the user to allocate the reward points to the deposit accounts 401 selected by the user.

The rewards management platform 202 prompts the user to select one or more deposit accounts 401 associated with the user for allocating the 9 reward points from the user account 402. If the user selects, for example, the facebook account 401b with a conversion rate of 1:4, the rewards management platform 202 converts the 9 reward points to 36 reward points, as exemplarily illustrated in FIG. 4F, and distributes the 36 reward points to the facebook account 401b on establishing an electronic connection with the facebook platform.

The rewards management platform 202 logs into the facebook platform using the login information provided by the user and distributes the 36 reward points to the user's facebook account 401b. Similarly, the user may select other deposit accounts 401, for example, the swagbucks™ account 401a, the charity deposit account 401c, the cash deposit account 401d, etc., for distributing the reward points accrued in the user account 402. In an embodiment, the rewards management platform 202 allows the user to drag and drop reward points into the selected deposit accounts 401 during allocation.

When the reward points allocated to each of the selected deposit accounts 401 reach the distribution threshold of each of the selected deposit accounts 401, the rewards management platform 202 distributes the reward points to the selected deposit accounts 401 on receiving a “cash-out” indication from the user. In an embodiment, the reward points undergo a conversion based on the conversion rate of each of the selected deposit accounts 401 during distribution of the reward points to the selected deposit accounts 401 as exemplarily illustrated in FIG. 4G.

Consider an example where the user allocates a subset of the reward points accrued in the user account 402 into a deposit account 401 having its own distribution threshold. If the allocated reward points in the selected deposit account 401 have not reached the distribution threshold of that deposit account 401, the rewards management platform 202 does not distribute the allocated reward points to the selected deposit account 401 on receiving a cash-out indication from the user. The rewards management platform 202 only distributes the allocated reward points to the selected deposit accounts 401, when the allocated reward points have reached their respective distribution thresholds. For example, consider the user is associated with a user account 402 having an allocation threshold of 2000 reward points. The user is therefore required to accrue 2000 reward points or more in the user account 402 to be eligible for allocating the reward points.

On accruing 2000 reward points in the user account 402, the rewards management platform 202 allows the user to allocate the reward points to different deposit accounts 401, for example, a cash deposit account 401d associated with a conversion rate of 1:1, a charity deposit account 401c associated with a conversion rate of 1:1, a facebook account 401b associated with a conversion rate of 1:4, etc. The cash deposit account 401d and the charity deposit account 401c each have a distribution threshold of, for example, 100 reward points. The facebook account 401b has a distribution threshold of, for example, 500 reward points. The user is therefore required to accrue at least 100 reward points or more in the cash deposit account 401d and the charity deposit account 401c and at least 500 reward points or more in the facebook account 401b to be “cash-out” eligible. Of the 2000 reward points in the user account 402, the user allocates 1000 reward points to the cash deposit account 401d, 800 reward points to the charity deposit account 401c, and 50 reward points to the facebook account 401b.

On conversion based on the conversion rate of 1:1 of the cash deposit account 401d by the rewards management platform 202, the rewards management platform 202 allocates the equivalent 1000 reward points to the cash deposit account 401d. On conversion based on the conversion rate of 1:1 of the charity deposit account 401c by the rewards management platform 202, the rewards management platform 202 allocates the equivalent 800 reward points to the charity deposit account 401c. On conversion based on the conversion rate of 1:4 of the facebook account 401b by the rewards management platform 202, the rewards management platform 202 allocates the equivalent 200 reward points to the facebook account 401b. Since only the reward points allocated to the cash deposit account 401d and the charity deposit account 401c reach their respective distribution thresholds, the rewards management platform 202 only distributes the 1000 reward points to the cash deposit account 401d and the 800 reward points to the charity deposit account 401c on receiving a “cash-out” indication from the user. The rewards management platform 202 does not distribute the 200 reward points to the facebook account 401b since the 200 rewards points allocated to the facebook account 401b do not reach the distribution threshold of the facebook account 401b.

In an embodiment, the rewards management platform 202 enables the user to cash-out one or more of the selected deposit accounts 401 at different points in time. In another embodiment, the rewards management platform 202 enables the user to reallocate the reward points between the deposit accounts 401. In an embodiment, the rewards management platform 202 charges the user a fee, for example, a percentage of the reward points, for reallocation of the reward points between the deposit accounts 401. For example, if the user moves 500 reward points from the cash deposit account 401d to the swagbucks™ account 401a, the rewards management platform 202 debits 1% of the reward points, that is, 5 reward points from the user account 402 as a fee. Furthermore, the rewards management platform 202 displays the reward points accrued in the deposit accounts 401 by the user over a period of time as exemplarily illustrated in FIG. 4G.

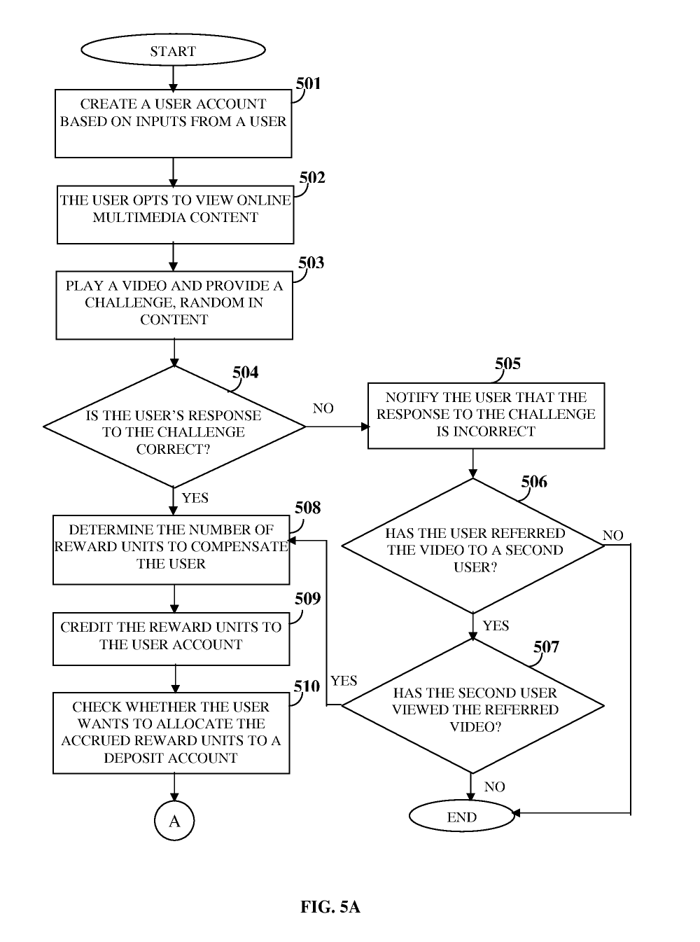

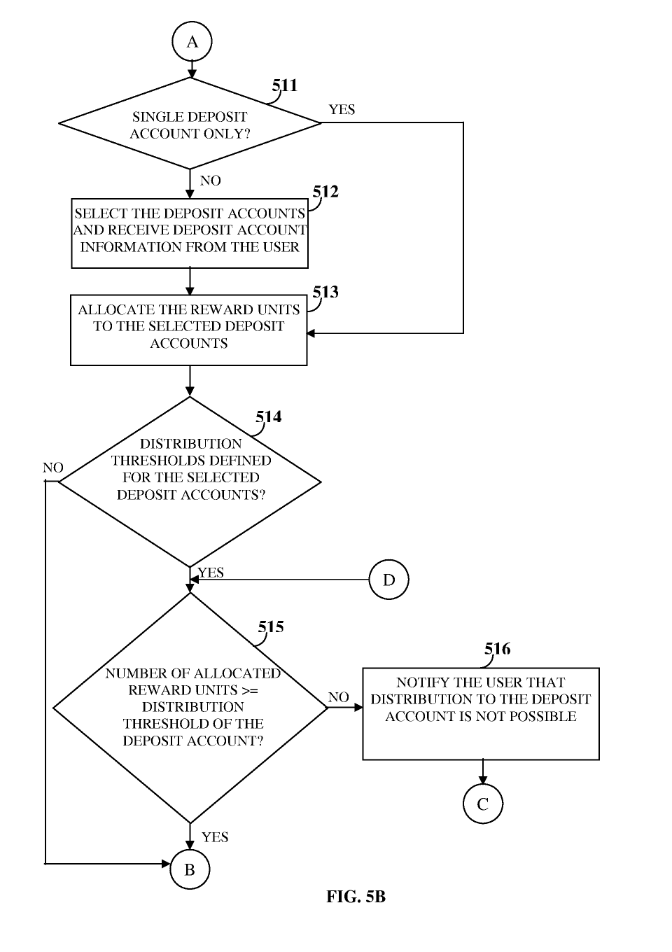

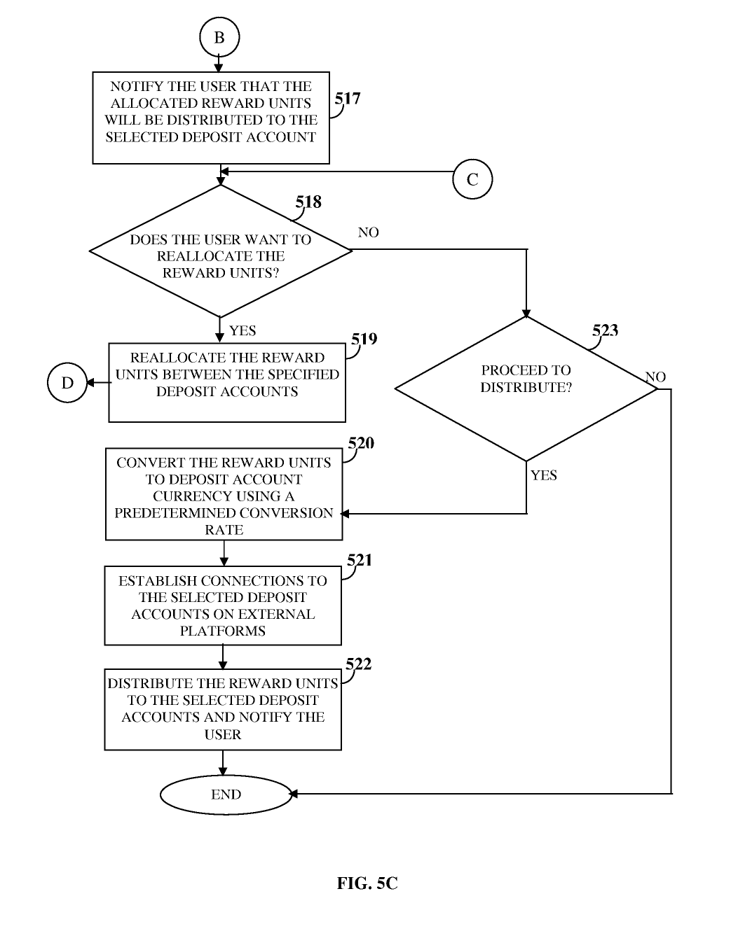

FIGS. 5A-5C exemplarily illustrate a flowchart comprising the steps for selectively distributing rewards to a user based on activities performed by the user on the rewards management platform 202. Consider an example where a user approaches the rewards management platform 202, exemplarily illustrated in FIG. 2, to avail compensation offered by the rewards management platform 202 for online activities performed by the user. The rewards management platform 202 creates 501 a user account 402 exemplarily illustrated in FIGS. 4B-4C based on inputs received from the user via the GUI 202k. The user, for example, provides inputs such as a login name, password, demographic information, default preferences, general interests and online activities in which the user is interested, etc. The rewards management platform 202 collects and stores information and inputs provided by the user in the user information database 202g and creates the user account 402 for the user.

The rewards management platform 202 checks whether the user wants to perform an online activity that is eligible for compensation. The rewards management platform 202 compensates the user with rewards, for example, if the user views a video 403 and responds to a challenge 404 correctly, or if the user refers the video 403 to other users who in turn view the referred video 403, etc. In this example, the user opts 502 to view online multimedia content, for example, an advertisement video 403 on the rewards management platform 202. The rewards management platform 202 plays 503 a video 403, for example, based on the interests of the user, and provides 503 a challenge 404, random in content, during or after the play of the video 403 as exemplarily illustrated in FIG. 4D. The challenge 404 is, for example, a random pair of digits that move randomly across the display screen 201a during play of the video 403. The user provides a response to the challenge 404. The rewards management platform 202 checks 504 whether the user's response to the challenge 404 is correct. If the user has not responded to the challenge 404 correctly, the rewards management platform 202 notifies 505 the user that the response to the challenge 404 is incorrect and prompts the user to make another attempt at responding to the challenge 404.

The rewards management platform 202 also provides another opportunity to the user to receive compensation based on a referral of the video 403 to one or more second users. The rewards management platform 202 checks 506 whether the user has referred the video 403 to a second user. If the user has not referred the video 403 to a second user, the rewards management platform 202 may, for example, notify the user of the other activities that the user can perform to gain compensation, and then ends the process. If the user has referred the video 403 to a second user, the rewards management platform 202 checks 507 whether the second user has viewed the referred video 403. If the rewards management platform 202 confirms that the referred second user has viewed the referred video 403, the rewards management platform 202 compensates the user and/or the second user.

If the rewards management platform 202 confirms that the second user has viewed the referred video 403, the rewards management platform 202 determines 508 the number of reward units, for example, reward points to compensate the user. For example, the rewards management platform 202 compensates the user who refers the video 403 to the second user with about 100% of the compensation received by the second user, because the referral resulted in the second user registering with the rewards management platform 202 to create a virtual community network. The compensation is, for example, 100 reward points. The rewards management platform 202 credits 509 reward units, that is, the 100 reward points to the user account 402. Further, the user and the second user can also refer the video 403 to other users to create the virtual community network on the rewards management platform 202, thereby allowing interaction between all the users who refer the video 403 to other users.

If the user's response to the challenge 404 is correct thereby confirming the viewing of the video 403, the rewards management platform 202 compensates the user with rewards for the correct response. In this example, the rewards management platform 202 compensates the user with a specific number of reward units, for example, reward points. The rewards management platform 202 determines 508 the number of reward units to compensate the user for the correct response. The rewards management platform 202 credits 509 the determined number of reward units, for example, a 100 reward points to the user account 402.

The rewards management platform 202 checks 510 whether the user wants to allocate the accrued reward units to a deposit account 401, exemplarily illustrated in FIG. 4A and FIG. 4F, selected by the user. The rewards management platform 202 first checks 511 whether the user has only a single deposit account 401. If the user has only a single deposit account 401, the rewards management platform 202 allocates 513 the reward units automatically to the single deposit account 401. If the user has more than one deposit account 401, the rewards management platform 202 enables the user to select 512 one or more of the multiple deposit accounts 401 held on the external platforms 204 via the GUI 202k of the rewards management platform 202 for allocation of the reward units and receives 512 deposit account information, for example, login information, from the user. In this example, the user selects a facebook account 401b held by the user on the facebook website, a cash deposit account 401d held by the user on a banking platform, and a charity deposit account 401c held by the user on a charity platform as exemplarily illustrated in FIG. 4A and FIG. 4F, for allocating the reward units accrued by the user. The rewards management platform 202 allocates 513 the reward units to the selected deposit accounts 401 based on the inputs received from the user via the GUI 202k. In this example, the rewards management platform 202 allows the user to allocate the accrued reward units to the selected deposit accounts 401, that is, the facebook account 401b, the cash deposit account 401d, and the charity deposit account 401c.

The rewards management platform 202 receives the login information for each of the selected deposit accounts 401 from the user to enable distribution of the reward units to each of the selected deposit accounts 401 after allocation by the user. The rewards management platform 202 checks 514 whether distribution thresholds have been defined for the selected deposit accounts 401. If a distribution threshold has been defined for a selected deposit account 401, the rewards management platform 202 further checks 515 whether the number of reward units allocated to the selected deposit account 401 is greater than or equal to the distribution threshold for the selected deposit account 401. If the allocated reward units for the selected deposit account 401 are greater than or equal to the distribution threshold for that selected deposit account 401, the rewards management platform 202 notifies 517 the user that the allocated reward units will be distributed to the selected deposit account 401. If the allocated reward units for the selected deposit account 401 are less than the distribution threshold for that selected deposit account 401, the rewards management platform 202 notifies 516 the user that the distribution of the allocated reward units to the selected deposit account 401 is not possible and that the user needs to allocate more reward units to the selected deposit account 401 for distribution. Further, the rewards management platform 202 allows the user to reallocate the reward units from another deposit account 401 to allow the reward units in the selected deposit account 401 to exceed the distribution threshold for that selected deposit account 401.

The rewards management platform 202 checks 518 whether the user wants to reallocate the allocated reward units of the selected deposit accounts 401 between any of the selected deposit accounts 401. If the user wants to reallocate the reward units between the selected deposit accounts 401, the rewards management platform 202 reallocates 519 the reward units between the deposit accounts 401 selected by the user. The rewards management platform 202 checks 515 whether the reward units accrued in the deposit account 401 to which the reward units have been recently allocated now exceed the distribution threshold. In an example, the user may want to reallocate the reward units accrued in the cash deposit account 401d to a facebook account 401b to obtain more virtual coins that could be used as virtual currency for facebook applications.

If the user does not want to reallocate the reward units to another deposit account 401, the rewards management platform 202 checks 523 whether the rewards management platform 202 can proceed to distribute the allocated reward units to the selected deposit accounts 401. The rewards management platform 202 first checks whether the user has sufficient number of reward units in the deposit account 401 to allow for distribution, and then requests the user to confirm final distribution of the reward units to the selected deposit accounts 401. If the user does not have sufficient number of reward units in the selected deposit account 401, and the user does not want to obtain reward units from another deposit account 401 by reallocation, the rewards management platform 202 terminates the process and the user is not compensated. If the user has sufficient number of reward units in the selected deposit account 401, for example, a number of reward units greater than the distribution threshold, the rewards management platform 202 proceeds with converting the reward units to an equivalent currency of the selected deposit account 401.

The rewards management platform 202 converts 520 the allocated reward units to an equivalent currency of the selected deposit account 401, that is, the deposit account currency, using a predetermined conversion rate. For example, the rewards management platform 202 converts the reward units accrued in the cash deposit account 401d to cash based on the conversion rate. In this example, the conversion rate for the cash deposit account 401d is 10:1. If the user has allocated fifty reward points to the cash deposit account 401d, the rewards management platform 202 converts the fifty reward points to five dollars for credit into the cash deposit account 401d on the banking platform. The rewards management platform 202 establishes 521 connections to the selected deposit accounts 401 on the external platforms 204 via the communication network 203. For example, the rewards management platform 202 connects to the charity deposit account 401c of the user on a charity platform by using login information of the charity deposit account 401c, and to the cash deposit account 401d on the banking platform using the details, login details, etc., of the cash deposit account 401d provided by the user. The rewards management platform 202 distributes 522 the reward units in the form of converted currency to the selected deposit accounts 401 and notifies the user.

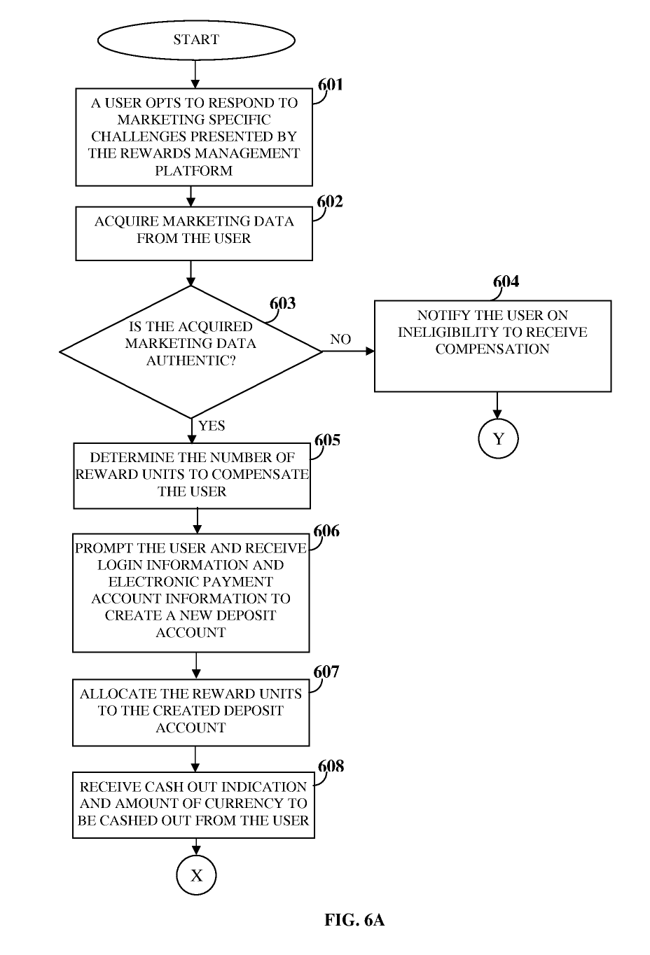

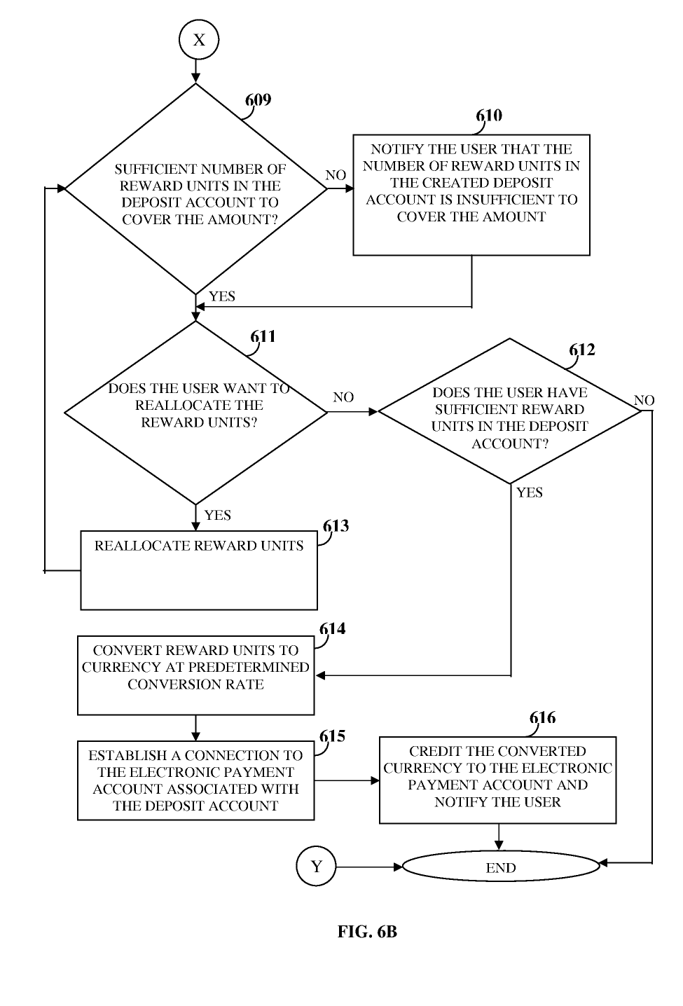

FIGS. 6A-6B exemplarily illustrate a flowchart for selectively distributing rewards to a user for transferring the rewards to an electronic payment account associated with the user. Consider an example where a user opts 601 to respond to marketing specific challenges presented by the rewards management platform 202 exemplarily illustrated in FIG. 2. The user provides marketing data, for example, a rating for the quality of a set of winter clothing brands, design and features that the user expects to find in a product, choices of cuisine, favorite music artist, buying preferences, product preferences, etc. The rewards management platform 202 acquires 602 the marketing data from the user. The rewards management platform 202 checks 603 whether the marketing data acquired from the user is authentic. For example, the rewards management platform 202 checks whether the marketing data provided by a user in a demographic group is consistent with the marketing data provided by all users of that demographic group to determine the authenticity of the marketing data provided by the user. If the acquired marketing data is authentic, the rewards management platform 202 compensates the user. Furthermore, the rewards management platform 202 targets the user with multimedia content based on the acquired marketing data. If the marketing data provided by the user is not authentic, that is, inconsistent with the marketing data of the demographic group, the rewards management platform 202 notifies 604 the user on ineligibility to receive compensation.

If the acquired marketing data is authentic, the rewards management platform 202 compensates the user with a specific number of reward units for providing consistent and reliable marketing data. The rewards management platform 202 determines 605 the number of reward units, for example, reward points to compensate the user. The rewards management platform 202 prompts 606 the user to create a new deposit account 401 exemplarily illustrated in FIG. 4A on the rewards management platform 202. Further, the rewards management platform 202 receives 606 the login information such as a preferred name and password, and electronic payment account information to allow direct transfer of physical currency such as cash from the created deposit account 401 to the electronic payment account. The electronic payment account is, for example, a PayPal™ account. The rewards management platform 202 allocates 607 the reward units to the created deposit account 401.

The rewards management platform 202 receives 608 a cash-out indication, the amount of currency to be cashed out, for example, the amount of cash to be transferred to the PayPal™ account, and a payee's details from the user via the GUI 202k. For example, the user intends to pay toll expenses incurred for a month to a toll company herein referred to as the “payee”. The payee's details comprise, for example, an account number and the name of the payee. The rewards management platform 202 checks 609 whether the number of reward units in the deposit account 401 is sufficient to cover the amount of currency to be cashed out. If the number of reward units in the deposit account 401 is insufficient, the rewards management platform 202 notifies 610 the user that the number of reward units in the deposit account 401 is insufficient to cover the amount and allow for the transfer of the amount of currency, and that the user needs to collect more reward units. Further, the rewards management platform 202 allows the user to reallocate the reward units from another deposit account 401 to the created deposit account 401 via the GUI 202k.

If the number of reward units in the deposit account 401 is sufficient, the rewards management platform 202 checks 611 whether the user wants to reallocate the reward units to another deposit account 401. If the user wants to reallocate the reward units to another deposit account 401, the rewards management platform 202 reallocates 613 the reward units to another deposit account 401 based on the number of reward units entered by the user for reallocation via the GUI 202k. The rewards management platform 202 then checks 609 whether a sufficient number of reward units have been collected in the created deposit account 401 after reallocation, to cover the amount of currency requested by the user.

If the user does not want to reallocate the reward units, the rewards management platform 202 checks whether the rewards management platform 202 can proceed to distribute the allocated reward units to the electronic payment account. The rewards management platform 202 first checks 612 whether the user has sufficient number of reward units in the deposit account 401 to allow for distribution, and then requests the user to confirm whether to proceed with final distribution of the reward units to the electronic payment account. If the user has sufficient reward units in the deposit account 401, the rewards management platform 202 proceeds with converting the reward units accrued in the created deposit account 401, for example, to a physical currency based on a predetermined conversion rate. If the user does not have sufficient reward units in the deposit account 401, the rewards management platform 202 notifies the user that the reward units accrued in the deposit account 401 on the rewards management platform 202 does not cover the requested amount of currency to be transferred to the electronic payment account, and terminates the process.

The rewards management platform 202 converts 614 the accrued reward units to currency, for example, cash, at a predetermined conversion rate agreed with the electronic payment account provider. For example, the rewards management platform 202 converts two hundred reward units accrued in the deposit account 401 to two hundred dollars at a conversion rate of 1:1. The rewards management platform 202 establishes 615 a connection to the electronic payment account associated with the deposit account 401 via the communication network 203, for example, using the electronic payment account information and login information received in step 606. The rewards management platform 202 credits 616 the converted cash of two hundred dollars directly to the electronic payment account, for example, the PayPal™ account, transfers the payee information to the electronic payment account, and notifies the user.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire and fiber optics, including wires that constitute a system bus coupled to a processor. Common forms of computer readable media comprise, for example, a floppy disk, a flexible disk, a hard disk, magnetic tape, any other magnetic medium, a compact disc-read only memory (CD-ROM), a digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors or like devices. Typically, a processor receives instructions from a memory or like device and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as object code. The computer program product disclosed herein comprises computer executable instructions embodied in a non-transitory computer readable storage medium, wherein the computer program product comprises computer program codes for implementing the processes of various embodiments.

Where databases are described such as the user information database 202g, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment including a computer that is in communication with one or more devices via a communication network. The computer may communicate with the devices directly or indirectly, via a wired medium or a wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, Sun® processors, IBM® processors, etc., that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

We claim:

1. A computer implemented method for selectively distributing rewards to a user, comprising:
providing a rewards management platform for managing said rewards of said user;
compensating said user with said rewards based on one or more activities performed by said user on said rewards management platform;
selecting one or more of a plurality of deposit accounts associated with said user via a graphical user interface provided by said rewards management platform for allocating one or more of said rewards, wherein each of said one or more deposit accounts is associated with a conversion rate;
establishing an electronic connection to each of said selected one or more deposit accounts by said rewards management platform via a communication network; and
distributing said allocated one or more rewards to said selected one or more deposit accounts based on said conversion rate by said rewards management platform via said established electronic connection.

2. The computer implemented method of claim 1, wherein said one or more activities performed by said user comprise one or more of opting to receive multimedia content from one or more of said rewards management platform and third party platforms, confirming viewing of said multimedia content by said user, referring said multimedia content to other users, accessing said referred multimedia content, registering into a virtual community network created on said rewards management platform based on referrals, and providing authentic marketing data for enabling targeting of said multimedia content to said user.

3. The computer implemented method of claim 2, wherein said confirmation of said viewing of said multimedia content comprises generating a challenge, random in content, presenting said generated challenge to said user, and invoking a response from said user to said presented challenge by said rewards management platform, wherein said challenge is one or more of unrelated to said multimedia content, presented at random times during play of said multimedia content and/or after play of said multimedia content, and presented at random physical locations on said multimedia content.

4. The computer implemented method of claim 1, further comprising creating one or more deposit accounts for said user on said rewards management platform based on inputs received from said user via said graphical user interface, wherein said user allocates one or more of said rewards to said created one or more deposit accounts via said graphical user interface for distribution to electronic payment accounts associated with said user.

5. The computer implemented method of claim 1, wherein said compensation of said user with said rewards by said rewards management platform comprises crediting said rewards to a user account created for said user on said rewards management platform based on inputs received from said user via said graphical user interface.

6. The computer implemented method of claim 1, wherein said rewards management platform provides said user with an electronic wallet associated with a user account created for said user on said rewards management platform for accruing said rewards over a period of time.

7. The computer implemented method of claim 1, further comprising converting said rewards to a currency based on said conversion rate and transferring said currency to a third party associated with said user via an electronic payment account associated with said user, by said rewards management platform on receiving an indication from said user via said graphical user interface for transferring said currency.

8. The computer implemented method of claim 1, further comprising reallocating one or more of said allocated one or more rewards between said deposit accounts associated with said user by said rewards management platform based on inputs received from said user via said graphical user interface prior to said distribution of said allocated one or more rewards to said deposit accounts.

9. The computer implemented method of claim 8, further comprising charging a fee to said user by said rewards management platform for said reallocation of said one or more of said allocated one or more rewards between said deposit accounts associated with said user.

10. The computer implemented method of claim 1, further comprising targeting multimedia content to said user by said rewards management platform during creation of a user account for said user on said rewards management platform.

11. The computer implemented method of claim 1, further comprising allowing said allocation of said one or more of said rewards to one or more of said selected one or more deposit accounts by said rewards management platform based on predetermined criteria.

12. The computer implemented method of claim 1, further comprising defining a distribution threshold for each of said deposit accounts by said rewards management platform, wherein said rewards management platform performs said distribution of said allocated one or more rewards to one or more of said selected one or more deposit accounts based on said distribution threshold.

13. The computer implemented method of claim 1, further comprising determining distribution criteria from said user via said graphical user interface by said rewards management platform, wherein said rewards management platform performs said distribution of said allocated one or more rewards to said selected one or more deposit accounts based on said distribution criteria.

14. The computer implemented method of claim 13, wherein said distribution criteria comprise time for distributing said allocated one or more rewards to said selected one or more deposit accounts by said rewards management platform, and number of units of said allocated one or more rewards to be distributed to said selected one or more deposit accounts at said time by said rewards management platform.

15. The computer implemented method of claim 1, further comprising selecting one or more of said selected one or more deposit accounts having said allocated one or more rewards by said user via said graphical user interface for said distribution of said allocated one or more rewards by said rewards management platform.

16. A computer implemented system for selectively distributing rewards to a user, comprising:
a rewards management platform that manages said rewards of said user, wherein said rewards management platform comprises:
a payment module that compensates said user with said rewards based on one or more activities performed by said user on said rewards management platform;
a deposit account selection module that enables selection of one or more of a plurality of deposit accounts associated with said user via a graphical user interface provided by said rewards management platform for allocating one or more of said rewards, wherein each of said one or more deposit accounts is associated with a conversion rate;
an allocation module that allocates said one or more of said rewards to said selected one or more deposit accounts;
a connection module that establishes an electronic connection to each of said selected one or more deposit accounts via a communication network; and
a distribution module that distributes said allocated one or more rewards to said selected one or more deposit accounts based on said conversion rate via said established electronic connection.

17. The computer implemented system of claim 16, wherein said allocation module reallocates one or more of said allocated one or more rewards between said deposit accounts associated with said user based on inputs received from said user via said graphical user interface prior to said distribution of said allocated one or more rewards to said deposit accounts.

18. The computer implemented system of claim 16, wherein said rewards management platform further comprises an account creation module that creates a user account for said user based on inputs received from said user via said graphical user interface for crediting said rewards on said rewards management platform.

19. The computer implemented system of claim 18, wherein said account creation module creates one or more deposit accounts for said user on said rewards management platform based on inputs received from said user via said graphical user interface, wherein said allocation module enables said user to allocate said one or more of said rewards to said created one or more deposit accounts via said graphical user interface for distribution to electronic payment accounts associated with said user.

20. The computer implemented system of claim 16, wherein said allocation module allows said allocation of said one or more of said rewards to one or more of said selected one or more deposit accounts based on predetermined criteria.

21. The computer implemented system of claim 16, wherein said distribution module defines a distribution threshold for each of said deposit accounts, wherein said distribution module distributes said allocated one or more rewards to one or more of said selected one or more deposit accounts based on said distribution threshold.

22. The computer implemented system of claim 16, wherein said distribution module converts said rewards to a currency based on said conversion rate and transfers said currency to a third party associated with said user via an electronic payment account associated with said user, on receiving an indication from said user via said graphical user interface for transferring said currency.

23. The computer implemented system of claim 16, wherein said distribution module determines distribution criteria from said user via said graphical user interface for distributing said allocated one or more rewards to said selected one or more deposit accounts, wherein said distribution criteria comprise time for distributing said allocated one or more rewards to said selected one or more deposit accounts by said distribution module, and number of units of said allocated one or more rewards to be distributed to said selected one or more deposit accounts at said time by said distribution module.

24. The computer implemented system of claim 16, further comprising a view confirmation module on one or more of said rewards management platform and a client device of said user, wherein said view confirmation module confirms viewing of multimedia content by said user, wherein said view confirmation module generates a challenge, random in content, that is one or more of unrelated to said multimedia content, presented at random times during play of said multimedia content and/or after play of said multimedia content, and presented at random physical locations on said multimedia content, presents said generated challenge to said user by one of overlaying said generated challenge on said multimedia content and inserting said generated challenge on interruption of play of said multimedia content, and invokes a response from said user to said presented challenge, and wherein said payment module communicates with said view confirmation module for compensating said user with said rewards based on said confirmation of said viewing of said multimedia content by said user.

25. The computer implemented system of claim 16, wherein said rewards management module further comprises a referral management module that enables referring of said multimedia content by said user to other users, monitors access of said referred multimedia content by said other users, and enables registration of said user and said other users into a virtual community network based on referrals, wherein said payment module communicates with said referral management module for compensating said user with said rewards based on said referring of said multimedia content to said other users.

26. The computer implemented system of claim 16, wherein said rewards management module further comprises a marketing module that acquires marketing data from said user via said graphical user interface, determines authenticity of said acquired marketing data, rates said acquired marketing data based on said determined authenticity, and targets said multimedia content to said user based on one or more of said determined authenticity and said rating of said acquired marketing data of said user, wherein said payment module communicates with said marketing module for compensating said user with said rewards based on said rating of said acquired marketing data.

27. The computer implemented system of claim 16, wherein said deposit account selection module enables selection of one or more of said selected one or more deposit accounts having said allocated one or more rewards by said user via said graphical user interface for said distribution of said allocated one or more rewards.

28. A computer program product comprising computer executable instructions embodied in a non-transitory computer readable storage medium, wherein said computer program product comprises:
a first computer program code for providing a rewards management platform for managing rewards of a user;
a second computer program code for compensating said user with said rewards based on one or more activities performed by said user on said rewards management platform;
a third computer program code for enabling selection of one or more of a plurality of deposit accounts associated with said user via a graphical user interface provided by said rewards management platform for allocating one or more of said rewards, wherein each of said one or more deposit accounts is associated with a conversion rate;
a fourth computer program code for establishing an electronic connection to each of said selected one or more deposit accounts by said rewards management platform via a communication network; and
a fifth computer program code for distributing said allocated one or more rewards to said selected one or more deposit accounts based on said conversion rate by said rewards management platform via said established electronic connection.
